(19) United States
(12) Patent Application Publication
(10) Pub. No.: US 2025/0390727 A1
(43) Pub. Date: Dec. 25, 2025

(54) RECURRENT NEURAL NETWORK AND RECURRENT NEURAL NETWORK DEVICE AND METHOD FOR TRAINING A RECURRENT NEURAL NETWORK

(71) Applicant: HORN Entwicklungsgesellschaft mbH, Munich (DE)

(72) Inventors: Wolf SINGER, Frankfurt am Main (DE); Felix EFFENBERGER, Frankfurt am Main (DE)

(21) Appl. No.: 18/879,280

(22) PCT Filed: Jul. 5, 2023
(86) PCT No.: PCT/EP2023/068565

§ 371 Date: Dec. 27, 2024

(30) Foreign Application Priority Data
Jul. 7, 2022 (EP) 22183567

(51) Int. Cl. G06N 3/063; G06N 3/044

(52) U.S. Cl. CPC G06N 3/063; G06N 3/044

(57) ABSTRACT

A recurrent neural network includes a plurality of n damped harmonic oscillators (DHOi), each of the n damped harmonic oscillators being one cell (nci) of the neural network, an input unit (IU) that receives and inputs time-series input data (S (t)), a recurrent connection unit (RCU) that includes, for each of the cells (nci), at least one connection (wi,j) between the input/output node (IOᵢ) of the corresponding cell (nci) and the input/output node (IOⱼ) of at least another one of the cells (ncj) for transmitting the resulting damped harmonic oscillation (hᵢ) output from the input/output node of the corresponding cell (nci) to the input/output node of the another one of the cells (ncj).

### CROSS-REFERENCE TO RELATED APPLICATIONS

This application is the U.S. National Stage of International Application No. PCT/EP2023/068565 filed on Jul. 5, 2023, which claims priority to European patent application no. 22 183 567.1 filed on Jul. 7, 2023.

### TECHNICAL FIELD

The present invention relates to a recurrent neural network, to a corresponding recurrent neural network device and to a method for training such a recurrent neural network.

### BACKGROUND OF THE INVENTION

Neural networks are widely known in the art. Examples are feed-forward networks, deep and convolutional neural networks (DNN), reservoir computing networks, recurrent neural networks (RNN), and other types of neural networks.

Despite their attractive properties, RNNs are less explored than purely feed forward DNNs because they are difficult to train with the back propagation through time (BPTT) algorithm due to the exploding and vanishing gradients (EVG) problem. A number of approaches have been proposed to make training of recurrent networks more tractable, from gradient scaling over restrictions on the recurrent weight matrix to gated architectures.

N. Benjamin Erichson et al., “LIPSCHITZ RECURRENT NEURAL NETWORKS”, arXiv:2006.12070v3 [cs.LG] 24 Apr. 2021 describe one of such approaches in which the RNN is viewed as continuous-time dynamical system described by a linear component and a Lipschitz non-linearity.

In other recent approaches, attempts have been made to leverage the complex dynamics of coupled oscillator networks for computations. For example, in one approach directed to hardware implementation, M. Romera et al. “Vowel recognition with four coupled spin-torque nano-oscillators”, Nature 563, 230-234, DOI: 10.1038/s41586-018-0632-y (2018), and M. Romera, et al. “Binding events through the mutual synchronization of spintronic nano-neurons”, Nat. Commun. 13, 883, DOI: 10.1038/s41467-022-28159-1 (2022), describe spin-torque nano-oscillators as natural candidates for building hardware neural networks made of coupled nanoscale oscillators as potential hardware implementations.

T. Konstantin Rusch and Siddhartha Mishra, “COUPLED OSCILLATORY RECURRENT NEURAL NETWORK (CORNN): AN ACCURATE AND (GRADIENT) STABLE ARCHITECTURE FOR LEARNING LONG TIME DEPENDENCIES”, arXiv:2010.00951v2 [cs.LG] 14 Mar. 2021, (hereinafter prior art 1=PA1) describes another one of these approaches, which is directed to the analysis of the performance of the corresponding algorithms, and in which a model of coupled oscillators is used in a RNN to create a coupled oscillatory Recurrent Neural Network (coRNN). The coRNN is trained using the BPTT algorithm and the paper describes that the EVG problem is mitigated with this CORNN.

W. Moy et al. “A 1,968-node coupled ring oscillator circuit for combinatorial optimization problem solving”, Nat Electron (2022), DOI: 10.1038/s41928-022-00749-3, (hereinafter prior art 2=PA2) describes a scalable ring-oscillator-based integrated circuit as an alternative to quantum-, optical- and spintronic-based approaches for computational architectures.

The different prior art approaches are directed to either mere task performance without any hardware implementation or to hardware implementation with relatively simple tasks or to solving specific application problems. At least some of the approaches need high computing power and/or specific temperatures, both leading to high energy consumption.

### SUMMARY OF THE INVENTION

Therefore, it is one non-limiting object of the present teachings to provide a solution for a computational architecture design that leverages the complex dynamics of networks of coupled damped harmonic oscillators, and that can be implemented equally and efficiently in hardware such as in electric digital or analogue hardware, e.g., in complimentary metal-oxide-semiconductor (CMOS) technology, and in software and that can be reliably trained with the back propagation through time (BPTT) algorithm and that is energy consumption efficient.

The RNNs of the present teachings may differ from known RNNs by several features, a very powerful one being differing natural frequencies of the damped harmonic oscillators.

Other optional powerful features are time delays in the connections and/or differing damping factors and/or a multilayer structure with specific connection structures in the same layer and/or different feedforward and feedback connections between the layers and/or different distributions of the natural frequencies between the layers.

The introduction of oscillating units allows for higher dimensional dynamic phenomena such as resonance, entrainment, synchronization, phase shifts and desynchronization and permits the generation of higher dimensional dynamic landscapes in a state space. The potential introduction of heterogeneity=non-homogeneity enhances these effects.

The design with oscillatory units interacting in a recurrent network enables designs of computational architectures that can be implemented equally in hardware or software and/or allows effective training of the networks using BPTT and/or enables implementation in semiconductor devices in which the final setting of the parameters of the recurrent network can be done after the training using software algorithms.

### BRIEF DESCRIPTION OF THE DRAWINGS

Additional features and advantages follow from the description of embodiments referring to the drawings, in which:

FIG. 1 shows a schematic connection diagram of a first embodiment of a recurrent neural network with n damped harmonic oscillators and connections between all n damped harmonic oscillators;

FIG. 2A shows a schematic diagram of a damped translatory mechanical harmonic oscillator, FIG. 2B shows a schematic diagram of a damped electrical RLC harmonic oscillator, and FIG. 2C shows a schematic diagram of a damped harmonic oscillator implemented with analog electric elements;

FIG. 3 shows a schematic circuit diagram of a second embodiment of a neural network with n damped harmonic oscillators in which only the connections between the first oscillator and the other oscillators are shown;

FIG. 4 shows a schematic circuit diagram of one of the damped harmonic oscillators of the second embodiment of the neural network of FIG. 3 showing details of the input/output node of the same;

FIG. 5A shows a schematic diagram of a VCO, FIG. 5B shows a schematic graph of the output power versus the frequency of such a VCO, and FIG. 5C shows an exemplary schematic CMOS implementation of such a VCO;

FIG. 6A shows the variance of the power spectral densities of the MNIST data for the number 7 shown in FIG. 6B;

FIG. 7A shows the waveform of one sample of speech data of a spoken digit of 1 s length, FIG. 7B shows the variance of the power spectral densities computed across the power spectral densities of 1000 samples, and FIG. 7C shows a diagram illustrating the increase in performance between a one-layer NHHORNN and a two-layer NHHORNN having the same number of cells in processing such data;

FIG. 8A shows a schematic diagram of a recurrent neural network of a third embodiment with diversity in the connectivity between groups of network cells in a general representation in FIG. 8A; different representations for explanation of the connectivity are shown in FIGS. 8B-8D;

FIG. 9 shows a schematic diagram of a two-layered recurrent neural network of a fourth embodiment with a first layer corresponding to the third embodiment of FIGS. 8A-8D;

FIG. 10A shows a schematic diagram of a recurrent neural network of a fifth embodiment with diversity in the connectivity between groups of network cells in a general representation in FIG. 10A; a different representation for explanation of the connectivity is shown in FIG. 10B;

FIG. 11A shows a schematic diagram of a three-layered recurrent neural network of a sixth embodiment with a first layer corresponding to the first embodiment of FIG. 1 in FIG. 11A; a schematic representation of the layers is shown in FIG. 11B, and

FIG. 12 shows an example of a recognition certainty level in MNIST recognition with a small NHHORNN of the present teachings.

### DETAILED DESCRIPTION OF THE INVENTION

In the following description of embodiments, terms written as one or more letters in bold print like U or y or LC indicated as ∈Rⁿ denote a vector with n vector elements Uᵢ or yᵢ or LCᵢ (i=1, 2, . . . , n) which are an element ∈ of the real numbers R and terms written as one or more letters in bold print like W indicated as W∈R^{n×m} denote an (n×m)-element matrix (i=1, 2, . . . , n; j=1, 2, . . . , m) with matrix elements w_{i,j} which are an element ∈ of the real numbers R.

The inventors started from considerations of biological neuronal systems such as the cerebral cortex. Neurobiological investigations of the cerebral cortex indicate that these neuronal networks comprise highly complex, non-linear dynamics capable of generating high-dimensional spatio-temporal patterns in a self-organized manner. These patterns manifest themselves as frequency varying oscillations, transient synchronisation or desynchronisation phenomena, resonance, entrainment, phase shifts, and travelling waves.

In the present teachings, such principles are preferably realized in natural neuronal systems in a new manner focussing on oscillatory units interacting in a recurrent network for the design of computational architectures that can be implemented equally in hardware or software.

The superior performance in comparison to prior art systems has been proven by quantitative assessment of task performance based on a number of standard benchmark tests for pattern recognition. Specifically, the recurrent networks of the present teachings were tested with regard to performance on pattern classification tasks on the well-known MNIST hand written digits data set, the more challenging EMNIST data set comprised of hand written digits and letters, and the much harder Omniglot data set consisting of 1623 different handwritten character classes from 50 different alphabets, as well as on speech recognition tasks based on the Free Spoken Digit Dataset that consists of recordings of 3000 spoken digits of 6 speakers. The different types of tasks already show that the recurrent neural networks of the present teachings excel on recognition of patterns in time series data independent of the actual content type of the tasks.

The biologically inspired recurrent neural networks of the present teachings are especially suitable for hardware implementation with low energy consumption and they are excellent with respect to learning speed, noise tolerance, hardware requirements and number of systems variables when compared to prior art RNNs having gated architectures such as Long Short-Term Memory (LSTM) and Gated Recurrent Unit (GRU) networks. In addition, analysis of these recurrent neural networks of the present teachings enables identification of the underlying mechanisms that bring about this increased task performance.

The recurrent neural networks (RNNs) of the present teachings are explained starting with a RNN developed by present inventors as a basic model and schematically represented for explanatory purposes in FIG. 1.

The basic model of the RNN can be considered as being composed of n damped harmonic oscillators (DHOi, i=1, 2, . . . , n)) that share the essential dynamic features, i.e., the oscillatory properties defined by a natural frequency ω₀ and dampening factor γ. Such an RNN is a homogeneous recurrent neural network composed of identical DHO cells. The cells are connected in an all-to-all fashion with no conduction delays and all nodes are tuned to the same preferred frequency (see FIG. 1). Such a homogeneous recurrent network composed of identical DHO cells will be identified as a Homogenous Harmonic Oscillator RNN (HHORNN) in the present teachings and represents a first non-limiting embodiment of the present invention. Such HHORNNs have been trained on a set of benchmark tasks using the backpropagation through time (BPTT) algorithm and allowing gain adjustments of all connections including the input connections to the network nodes, the recurrent connections and the output connections.

The oscillation of each single DHO cell of such a HHORNN can be considered as following the general second order differential equation (1) for damped harmonic oscillators of

$${x}_{i} ( t ) : {\ddot{x}}_{i} ( t ) + 2 {β}_{i} {\dot{x}}_{i} ( t ) + {ω}_{0 i}^{2} {x}_{i} ( t ) \qquad ( 1 )$$

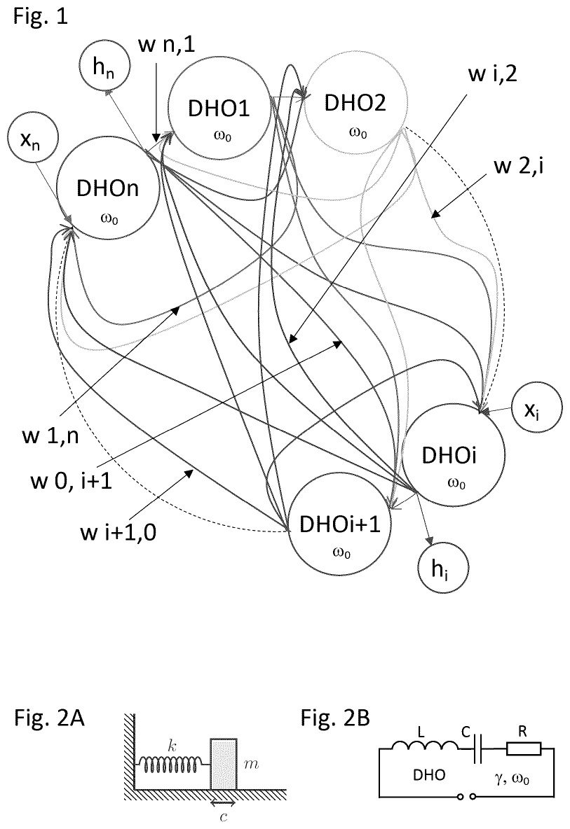

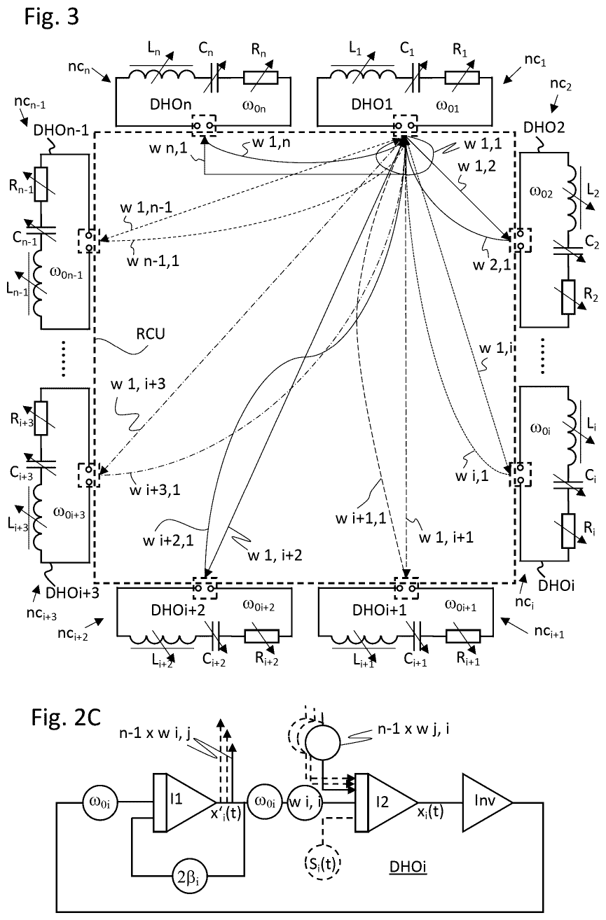

with βᵢ=damping factor and ω₀ᵢ=natural frequency of an undamped oscillation such as βᵢ=cᵢ/2mᵢ and ω₀ᵢ²=kᵢ/mᵢ, mᵢ=mass, kᵢ=spring constant and cᵢ=viscous damping constant for a corresponding damped translatory mechanical harmonic oscillator DHOi (see FIG. 2A), or βᵢ=Rᵢ/Lᵢ and ω₀ᵢ²=1/LᵢCᵢ, Rᵢ=resistance, Lᵢ=inductance and Cᵢ=capacity for a corresponding damped electrical RLC harmonic oscillator DHOi (see FIG. 2B), and the like for other types of damped harmonic oscillators. One example of another type of damped harmonic oscillator is shown in FIG. 2C below FIG. 3, in which the DHO is implemented by analog elements such as operation amplifiers, inverters, potentiometers etc., in the shown example e.g., two operation amplifiers used as integrators 11, 12, one inverter and several potentiometers used as weighing coefficients wi,j, and to represent (and set) the damping factor as 2B; and the natural frequency as ω₀ᵢ. As the potentiometers cannot realize coupling/weighing coefficients wi,j larger than 1, operation amplifiers or other amplifying elements can be used instead of the potentiometers, if wished and required. In the HHORNNs, βᵢ=βⱼ and ω₀ᵢ²=ω₀ⱼ² for all i, j. Nevertheless, the above notation with indices i, j is also used for the HHORNNs because this more general description can be also used for the description of the DHOs of other RNNs of the present teachings.

The electrical properties of a network of coupled electrical RLC circuits that are designed to have certain properties of biological neural networks can be defined as follows: A series of connected electrical RLC circuits driven by an external input, for which the Kirchhoff equation for voltages is valid, follows the equation:

$${U}_{L} + {U}_{R} + {U}_{C} = {U}_{ext} \qquad ( 2 )$$

Equation (3) follows from introducing the resistance R, the inductance L and the capacitance C into equation (2)

$$L \frac{dI ( t )}{dt} + RI ( t ) + U ( 0 ) + \frac{1}{C} {\int }_{0}^{t} I ( τ ) d τ = {U}_{ext} ( t ) \qquad ( 3 )$$

A system of n additively coupled DHOs implemented by RLC circuits described by equation (3) and driven by a time-varying external input Uₑₓₜ(t)∈Rⁿ and differentiated once to obtain a system of ordinary differential equations can be written in vector form with input I(t)∈Rⁿ as equation (4):

$$\frac{{d}^{2} I ( t )}{{dt}^{2}} + \frac{R}{L} \frac{dI ( t )}{dt} + \frac{1}{LC} I ( t ) = \frac{1}{L} \frac{{dU}_{ext} ( t )}{dt} \qquad ( 4 )$$

The following is an important characteristic of the RNNs of the present teachings. We assume and design the neural networks such that any external input into any DHO is determined by non-linear coupling of the activity across the recurrent neural network and the external signals. This non-linear coupling is expressed as equation (5):

$$\frac{{dU}_{ext} ( t )}{dt} = {F}_{NL} ( \frac{dI ( t )}{dt} , {S}_{ext} ) = σ ( W \frac{dI ( t )}{dt} + {S}_{ext} ) \qquad ( 5 )$$

wherein W∈R^{n×n} denotes pairwise coupling weights w_{i,j} as an (n×n)-element matrix (i=1, 2, . . . , n; j=1, 2, . . . , n) and Sₑₓₜ=Sₑₓₜ(t)∈Rⁿ is the vector of the input signal.

To obtain a final system of first order differential equations, x=I(t) and y=dI(t)/dt are substituted in equation (4) to obtain equations (6):

$$\frac{dy}{dt} = \frac{R}{L} y - \frac{1}{LC} x + \frac{1}{L} {F}_{NL} ( y , {S}_{ext} ) \\ \frac{dx}{dt} = y \qquad ( 6 )$$

The equations (6) describe a HHORNN as shown in FIG. 1, wherein the DHOs are implemented as RLC circuits as shown in FIG. 2B. However, in order to train the HHORNN using BPTT, a discrete time description of the HHORNN is needed. This in turn requires a numerical integration scheme. For this purpose, a well-known Euler discretization of (6) with time constant τ can be used, resulting in equations (7):

$${y}_{t + 1} = {y}_{t} + τ ( - \frac{R}{L} {y}_{t} - \frac{1}{LC} {x}_{t} + \frac{1}{L} {F}_{NL} ( y , {S}_{ext} ) \\ {x}_{t + 1} = {x}_{t} + τ {y}_{t} \qquad ( 7 )$$

The above equations describe a HHORNN as shown in FIG. 1, wherein the DHOs are implemented as RLC circuits as shown in FIG. 2B, that can be trained as a recurrent neural network. Training the HHORNN using BPTT means that the pairwise coupling weights w_{i,j} in W∈R^{n×n} are adjusted to minimize the error (costs). In other words, the connections w_{i,j} between the cells DHOi are adjusted in the representation shown in FIG. 1. This training includes the coupling weights for the input and the output as will be also evident from the description of the input unit and the output unit further below.

Each of the connections w_{i,j} between the cells DHOi can be set (adjusted) to a transmission characteristic T_{i,j}=w_{i,j}×hᵢ with w_{i,j}∈R being the pairwise coupling weights and |w_{i,j}|≤10. If a pairwise coupling weight is set to |w_{i,j}|=0, the connection from cell DHOi to cell DHOj is not present or interrupted.

The recurrent neural networks of the present teachings cover not only the above described HHORNNs, but also cover recurrent neural networks composed of DHOs that are non-homogenous. Non-homogenous means that they do not comprise only one type of DHO cells with the same β=damping factor and the same ω₀=natural frequency of an undamped oscillation of the DHO but that the plurality of n damped harmonic oscillators (DHOi, i=1 to n) of the RNN comprises at least two different types of damped harmonic oscillators, wherein each of the at least two different types of damped harmonic oscillator differs in at least the parameter ω₀ᵢ=natural frequency of an undamped oscillation from the other type(s) of damped harmonic oscillator(s).

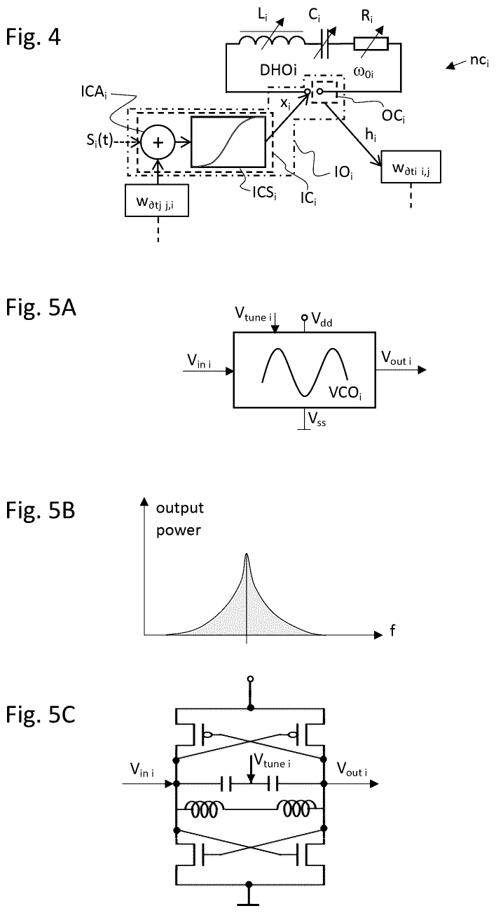

Such a recurrent network composed of DHO cells with at least two different types of damped harmonic oscillators will be identified as an Non-Homogenous Harmonic Oscillator RNN (NHHORNN) in the present teachings. Such an NHHORNN represents a second non-limiting embodiment of a recurrent neural network of the present teachings. An NHHORNN with n damped harmonic oscillators is described referring to FIGS. 3 and 4.

In FIG. 3, the n damped harmonic oscillators DHOi (i=1, 2, . . . , n) are schematically shown similar to the arrangement in FIG. 1 in a kind of circular arrangement, although it is a rectangle in FIG. 3. The circular-like arrangement is shown only for explanatory purposes to simplify the schematic representation of the connections. The number n of damped harmonic oscillators of the present teaching is n≥8, such that the representation in FIG. 3, if n=8 is selected, shows all 8 damped harmonic oscillators DHOi, i=1, 2, . . . , 8. The damped harmonic oscillators DHOi are shown as damped electrical RLC harmonic oscillators. Each of the damped harmonic oscillators is shown to comprise a resistance Rᵢ, an inductance Lᵢ and a capacitance Cᵢ which can be individually set or predetermined for each of the harmonic oscillators DHOi. As a consequence, in particular the damping factor βᵢ and the natural frequency ω₀ᵢ of the undamped oscillation of each of the damped harmonic oscillators can be set or predetermined independent of the corresponding parameters of each of the other damped harmonic oscillator DHOj. An NHHORNN comprises at least two damped harmonic oscillators DHOi with different natural frequency ω₀ᵢ of the undamped oscillation.

It is emphasized that HHORNNs and NHHORNNs according to the present teachings are not limited to an implementation with electric oscillators of the RLC type but could be also implemented e.g. with mechanical damped harmonic oscillators DHOs. In this case the corresponding damped translatory mechanical harmonic oscillators schematically shown in FIG. 2A follow the same general second order differential equation (1) for damped harmonic oscillators with βᵢ=cᵢ/2mᵢ and ω₀ᵢ²=kᵢ/mᵢ, mᵢ=mass, kᵢ=spring constant and cᵢ=viscous damping constant for a corresponding damped translatory mechanical harmonic oscillator DHOi. Other alternatives are e.g. implementations with secondary (galvanic) cells, with chemical oscillatory systems such as coupled Belousov-Zhabotinsky reactions, and, of course, in a computer program/software. With the representation of the analog DHOi in FIG. 2C below FIG. 3, it is obvious that one or more of the electric oscillators of the RLC type could e.g. be replaced by such an analog DHOi.

In the embodiment of an NHHORNN as shown in FIG. 3, an all-to-all connectivity including self-connectivity, i.e., the connection of the DHO to itself, is provided, meaning that the input/output nodes IOᵢ of all damped harmonic oscillators DHOi are potentially connected to the input/output nodes IOⱼ of all other damped harmonic oscillators DHOj and to the own input/output node IOᵢ for input and for output. In FIG. 3, for the purpose of illustration, only the connections from the first damped harmonic oscillator DHO1 to all other damped harmonic oscillators DHO2 to DHOn, namely w1,2, w1,3, . . . to w1,n, and the connections from the input/output nodes of all other damped harmonic oscillators DHOj, j=2, 3, . . . , n, to DHO1, namely w2,1, w3,1, . . . to wn,1, and the connection to itself w1,1 are shown. The other connections of the all-to-all connectivity are also potentially present but not shown for the reason of simplifying the illustration. The characteristics of the connections wi,j and their implementation will be described further below.

Referring to FIG. 4, one cell ncᵢ of the damped harmonic oscillators DHOi and its input/output node IOᵢ are shown in more detail. Such a single dynamic harmonic oscillator DHOi with its input/output node IOᵢ forms one cell nci of the recurrent neural network. The input/output node IOᵢ comprises an input connection ICᵢ generating the cell input xᵢ. The input connection ICᵢ comprises an adder ICAᵢ receiving all inputs via the connections wj,i from itself and all other cells of the recurrent neural network and, if the corresponding input/output node IOᵢ of the corresponding cell is connected to the input receiving the external signal S to be processed, the adder ICAᵢ is adapted to additionally receive the corresponding input signal Sᵢ(t), if applicable. For this reason, the input of Sᵢ(t) is shown with a hatched arrow line representing the potential connection. The same is true for FIG. 2C, in which the input Sᵢ(t) is shown with a hatched arrow line. The signal S and the input of the signal S will be described further below.

The output of the adder ICAᵢ is connected to an input element ICSᵢ which implements a non-linear, preferably a saturating non-linear such as a sigmoid-like optionally with offset or more preferably tanh-like, transfer function to generate the cell input xi from the output signal of the adder ICAᵢ. Semiconductor circuits for implementing a non-linear saturating, such as a sigmoid-like, transfer function either in single type transistor technology or CMOS technology are described e.g. in US 2018/0307977 A1. Therefore, the description of a specific hardware implementation of this input element ICSᵢ is omitted here as US 2018/0307977 A1 includes numerous examples.

The input/output node IOᵢ comprises an output connection OCᵢ, which outputs the resulting damped harmonic oscillation hᵢ to the corresponding connections wi,j.

FIG. 4 does not show in detail the input into the DHO and the output from the DHO. Only by way of a non-limiting example, it is referred to FIGS. 5A to 5D showing a Voltage Controlled Oscillator (VCO), which could be an implementation of the DHO. Such a VCO could be implemented, for example, in CMOS as schematically shown in FIG. 5C. In FIG. 5C, the input voltage V_{in i} and the output voltage V_{out i} are shown at the corresponding nodes. In this respect, it has to be noted that, in case of such a complementary CMOS VCO, the input and output voltages are phase shifted by 180° such that, if the same should be in phase, one inverter could be added either at the input or the output side. However, for the purpose of implementing the HHORNNs and the NHHORNNs of the present teachings and for calculating the characteristics of such HHORNNs/NHHORNNs, it is irrelevant whether there is such a phase shift between the input and output or not, as both are possible in this implementation.

Returning to FIGS. 3 and 4, the representations of the connections wj,i for the input and of the connections wi,j for the output include additionally the indications ∂tᵢ and ∂tⱼ. These indications indicate optional time delays in the connections, which can be present but do not need to be present (=optional) and which are described further below.

All these connections wi,j form a recurrent connection unit RCU which comprises all connections wi,j between the input/output nodes IOᵢ of all cells of the recurrent neural network. The recurrent connection unit RCU is represented by the hatched box RCU in FIG. 3. All the connections of the recurrent connection unit RCU can be described in a (n×n) matrix W with the matrix elements wi,j (i, j=1, 2, . . . , n).

These recurrent neural networks implemented as HHORNNs or NHHORNNs are suitable for effective processing of time-series input data S(t). The RNN comprises an input unit IU for receiving and inputting such time-series input data S (t) and an output unit OI adapted for outputting the result, i.e., the output data O(t).

In the simplest form, the input unit IU for receiving and inputting such time-series input data S (t) is one single connection to the input connection ICᵢ of the input/output node of one of the cells DHOi, as shown in an exemplary manner in FIG. 4. The simplest form of the output unit OI adapted for outputting the result, i.e., the output data O (t), is a connection to the output connection OCᵢ of the input/output node of one of the cells DHOi, which could be the same or another cell than the one connected to the input unit. The output unit is additionally adapted to start the output at a starting time OST which is set to be later than the first input of input data S (t) by at least five times the time series interval ti1 of input data S (t) (described further below) after the receipt of the first input of input data S (t), preferably ten times and more preferably twenty times ti1 thereafter. The output data are output with an output time interval to2 which can be identical to ti1 or different. The number of cells forming the input unit or connected to the input unit and the number of cells forming the output unit or connected to the output unit can be freely selected. For example, if the recurrent neural network comprises n=16 damped harmonic oscillators, all 16 cells could be connected to receive the input data S and 8 of the 16 cells could output the output data from the output unit. Or, 8 of the 16 cells could be connected to receive the input data S and the other 8 of the 16 cells could output the output data from the output unit, and so on.

The simplest form of the recurrent neural network of the present teachings is a network having n=8 damped harmonic oscillators. The number of damped harmonic oscillators is not limited per se but for practical reasons the number of DHOs in a network layer may be limited to 10⁶ or preferably to 250000 or 102400 or 40000 or 10000 or 2500 or 1024 or 512.

The above described RNN of FIG. 3 can be described by equations (8):

$$\frac{dy}{dt} = - β \cdot y - {ω}_{0}^{2} \cdot x + \frac{1}{L} σ ( W \frac{dI ( t )}{dt} + {S}_{ext} ( t ) ) \\ \frac{dx}{dt} = y \\ wherein β ∈ {ℝ}^{n} with {β}_{i} = \frac{{R}_{i}}{{L}_{i}} , {ω}_{0}^{2} ∈ {ℝ}^{n} with {ω}_{0 i}^{2} = \frac{1}{{L}_{i} {C}_{i}} , and \frac{1}{L} ∈ {ℝ}^{n} {with [ \frac{1}{L} ]}_{i} = \frac{1}{{L}_{i}} . \qquad ( 8 )$$

This description corresponds to equations (6) with a replacement of the scalars R/L and 1/LC and 1/L by the corresponding vectors. In order to train the NHHORNN, a numerical solution method is needed. For this purpose, a well-known Euler discretization of (8) with time constant τ can be used, thereby resulting in equations (9):

$${y}_{t + 1} = {y}_{t} + τ ( \frac{1}{L} σ ( W \frac{dI ( t )}{dt} + {S}_{ext} ( t ) ) - β \cdot {y}_{t} - {ω}_{0}^{2} \cdot {x}_{t} ) \\ {x}_{t + 1} = {x}_{t} + τ {y}_{t} \qquad ( 9 )$$

The above equations describe an NHHORNN as shown in FIGS. 3, 4 that can be trained as a recurrent neural network. Of course, the above equations can be equally used to describe a HHORNN as shown in the FIG. 1, if βᵢ=βⱼ and ω₀ᵢ²=ω₀ⱼ² for all i, j.

In the following, the original setup for such a recurrent neural network of the present teachings and the training thereof are explained.

As already mentioned above, the training of recurrent neural networks with the BPTT technique is fundamentally difficult due to the well-studied issue of exploding and vanishing gradients (EVG problem). This EVG problem occurs when gradients of the loss function used for training for long-term dependencies are not able to propagate properly through recurrent iterations of the recurrent network. However, the HHORNNs and as a consequence also the NHHORNNs do not face this problem. The mathematical proof is given in PA1 and will not be discussed here.

One conclusion can be drawn for an implementation in electrical hardware, especially CMOS or other semiconductor implementations: For given values of R and L, the value of the capacitance C determines the characteristics of the DHOs. Especially L may be difficult to set at a late stage of a semiconductor implementation, i.e., when the overall structure of the HHORNN or NHHORNN is defined but the HHORNN or NHHORNN still needs to be trained, either initially or to learn “new things”. But the capacitance can be set relatively easily stepwise or even continuously over a relatively wide range at a late stage by a bank of varactors (=variable capacitors) that are well established semiconductor elements and can be programmed to be changed at any time or otherwise fixedly set with fusions or the like at a late stage of hardware implementation.

Accordingly, the selection of the same parameters β and ω₀ for all DHOs in case of a HHORNNN or of the potentially different parameters βᵢ and ω₀ᵢ for an NHHORNN for the original or initial setup of the HHORNN/NHHORNN to be trained is one issue of the original setup. In general, it is possible and also effective to simply select the one ω₀ for the DHOs of a HHORNN to be in (=overlap with) the expected frequency range of the input signal. And in general, it is possible and also effective to simply select the different ω₀ for the DHOs of an NHHORNN to cover a wide field of frequencies with preferably overlapping receptive frequency ranges of the DHOs. Overlapping receptive frequency ranges means, referring to FIG. 5B, that the corresponding DHO can be expected to oscillate at least with a relevant output power amplitude of 1/10 or 1/e of the maximum output power when excited at the corresponding frequency. This wide field of frequencies should, of course, preferably overlap with the expected frequency range of the input signal. The above discussed overlaps are not strictly required for the HHORNN/NHHORNN but much preferred to enhance the performance.

This leads to the input signal S(t). The present techniques are designed to process time-series input data (S (t)). These time-series input data (S (t)) can be either discrete or continuous time-series input data (S (t)) with a time series interval ti1 and a time series length TI1, where the time series interval ti1 of the time-series input data (S (t)) represents either the time interval between subsequent discrete values in case of discrete time-series input data (S (t)) or the time interval between subsequent sampling values of continuous time-series input data (S (t)) such as sine-type signals. That means that the data to be processed are represented as such time-series input data (S (t)).

If the data to be processed are e.g. the MNIST data set, which consists of 60000 samples of handwritten digits where each sample consists of 28 by 28 intensity values representing one hand written digit of one of the digits 0 to 9, the same are turned (transformed) e.g. into a time-series data set D of length TI1=784 by collecting the pixels of each digit in scanline order from top left to bottom right. The clock rate 1/ti1 for inputting this time-series data sets the time interval ti1. It is noted that the clock rate corresponding to the time series interval ti1 can be freely selected.

If the data to be processed are speech data, where each data set consists of speech data of a certain length in real time with relevant frequencies in the range from e.g. 500 to 16000 Hz, the same are sampled at a specific sampling rate and transformed into a time-series data set with a time series interval ti1 and a time series length TI1.

Whatever the content of the data to be processed is, once they are either originally in the form of time-series input data (S (t)) or transformed into time-series input data (S (t)), the time-series input data (S (t)) to be processed such as the MNIST data set or any other data set represent a plurality of samples of the time-series input data (S (t)) to be processed and the plurality of samples of the time-series input data (S (t)) to be processed have power spectral densities and a variance of these power spectral densities.

The parameters ω₀ᵢ=natural frequency of the undamped oscillations of the different types of damped harmonic oscillators of an NHHORNN are preferably set such that, based on a determination of the power spectral density of a plurality of samples of the time-series input data (S (t)) to be processed and the variance of these power spectral densities, the natural frequencies are distributed over the peaks of this variance with one of the natural frequencies set to correspond to the peak of the variance with the lowest frequency and the other natural frequencies are distributed over the frequency range of the variance. In case of a HHORNN, the parameter ω₀=natural frequency of the undamped oscillations of the damped harmonic oscillators of the NHHORNN can be chosen according to the power spectral density of a plurality of samples of the time-series input data (S (t)) to be processed and the variance of these power spectral densities. The natural frequency ω₀ (for the case of a HHORN) or the natural frequencies ω₀ᵢ are preferably set to correspond to a peak of the variance of the power spectral densities of the input.

The connections wi,j between the input/output node IOᵢ of one corresponding cell and the input/output node IOⱼ of another one of the cells of the recurrent connection unit RCU are set to a transmission characteristic T_{i,j}=w_{i,j}×hᵢ with w_{i,j}∈R and |w_{i,j}|≤10. In other words, the strength/amplitude of the output of the one cell can be set to 0 by |w_{i,j}|=0 or can be set to either amplification by 1<|w_{i,j}|≤10 or kept at the same level by |w_{i,j}|=1 or weakened by |w_{i,j}|<1 and the output can be inversed with the corresponding amplitudes. It is also possible to set |w_{i,j}|≤5 or ≤3 or ≤2. This can be implemented by an electric voltage divider or a transmission gate coupling or other known circuitry for the output hᵢ of the corresponding damped harmonic oscillator. An example of such a transmission gate coupling that enables 5 different levels to be set with inversion is shown in FIG. 2 of PA2. Other circuitry can be implemented using an amplifier with a preset amplification ratio, whose amplification ratio is preset via a value stored in a memory bank for setting the connections values.

These connections and their characteristics are elements to be trained in the training of the HHORNN of FIG. 1 and the NHHORNN of FIG. 3.

As already mentioned before, although the NHHORNN of FIG. 3 does not include such transmission delays, the connection wi,j between the input/output node IOᵢ of one corresponding cell and the input/output node IOⱼ of another one of the cells of the recurrent connection unit RCU can be set not only to a transmission characteristic T_{i,j} as described above but can be optionally also set to a transmission delay. Such an output time delay ∂t_{i,j}=k_{i,j}×Δt, k_{i,j}=0, 1, . . . , k, 0≤k≤kmax, ti1/10≤Δt≤ti1 and k_{i,j}×Δt≤50 ti1, can be, for example, implemented by a series connection of inverters or a clocked output gate for the transmission of the output hᵢ of the corresponding damped harmonic oscillator. If such transmission delays are provided, the NHHORNN can be described by replacing the term with matrix W in equations (9) by the sum of k products of matrices Wₖ multiplied with the corresponding vector of the input change at the corresponding time tₖ=t−(k×Δt) leading to equations (10):

$${y}_{t + 1} = {y}_{t} + τ ( \frac{1}{L} σ ( {\sum }_{k = 0}^{kmax} {W}_{k} \frac{dI ( {t}_{k} )}{dt} + {S}_{ext} ( t ) ) - β \cdot {y}_{t} - {ω}_{0}^{2} \cdot {x}_{t} ) \\ {x}_{t + 1} = {x}_{t} + τ {y}_{t} \qquad ( 10 )$$

The maximum value kmax for k can be set to be 1000 or 500 or 100 or smaller than 100 such as 50, 40, 30, 20, 16 or 12 or 10 or 8 or 5 or 4 or 3 or 2. Preferred are values for kmax in the range of 30 to 10. Important to note is that the complexity of the description of the system is not increased by introducing the delays because the matrices Wₖ include only one element ≠0 at each position i,j for all k. Therefore, the calculation effort for the training is not increased but the performance of the HHORNNs/NHHORNNs is increased.

The input signal S(t) is input via an input unit IU which is connected to the input connection ICᵢ of the input/output node(s) of one or more of the cells nci. The input unit IU can be formed either by selected ones of the cells nci of the neural network itself or by a separate unit. The input signal can be input in this way into one single cell or a number nI of cells with nI≤n. The data forming the input signal can be input serially or in parallel into plural cells. Accordingly, the input signal can be described in general form as:

$${S}_{ext} ( t ) = WI \cdot D ( t ) \qquad ( 11 )$$

wherein Sₑₓₜ=Sₑₓₜ(t)∈Rⁿ is the vector of the input signal, WI∈R^{n×q} denotes pairwise coupling weights wi_{i,j} as an (n×p)-element matrix (i=1, 2, . . . , n; p=1, 2, . . . ) for the input into the cell/cells nci of the neural network selected (predetermined) to receive the input from the input unit. For example, if only one cell ncr of the cells nci of the neural network should receive input, this can be described such that only the matrix elements wi,j for i=r (the i-th row) can be different from 0 and for i≠r (all other rows) the matrix elements are 0. If only one data value per input cycle should be input, only one vector element d of the vector D(t)∈R^{q} has potentially a value ≠0, in other words q=1. If a number of q≠1 data values should be input in the same input cycle (time interval ti1), the vector D(t)∈R^{q} has q elements which potentially have a value≠0.

The above descriptions of the HHORNNs and of the NHHORNNs provide a design tool to study how the electrical properties of the DHOs and their connections, in other words of the “neural circuits”, determine the learning capabilities of the system and thus the overall capabilities of the trained network and which design changes lead to which capability or performance changes. The above descriptions of the HHORNNs and of the NHHORNNs also provide a tool to endow the DHOs and their connections with input and output, in other words to implement the HHORNNs/NHHORNNs in software to be run on a correspondingly programmed data processing device. The HHORNNs/NHHORNNs could also be hardware-implemented with mechanical elements such as spring supported weights, and the important non-linear saturating input element could be implemented by a viscoelastic input element or hydraulic or pneumatic input elements with such a force transfer. However, the hardware-implementation in form of an electric circuitry implementation, in particular the semiconductor circuit implementation, is presently preferred.

The training of the HHORNNs/NHHORNNs was performed on a number of classification benchmark tasks commonly used to evaluate RNN performance. The same was done with LSTM and GRU gated networks, at present the de-facto state of the art for RNN architectures in machine learning.

In all cases, the input data has been presented sequentially to the network in the form of time-series data and the networks were trained in a supervised way using back propagation through time (BPTT). All the networks were implemented in the PyTorch® framework and trained with BPTT. To achieve comparability across different network architectures, network sizes were chosen so that the effective number of trainable parameters is the same across all networks, with the default choice being 10000 parameters unless otherwise stated. For all tasks, a training batch size of 128 and the AdamW optimizer were used. For network architectures that suffer from exploding and vanishing gradients (GRU, LSTM), a parameter search in the space of learning rates and gradient scaling values was used to determine an optimal configuration of learning rate and gradient scaling for each model. As a measure for task performance of a network, the classification accuracy on a test set was calculated. To assess learning speed these accuracies were computed throughout the training process, evenly sampled across m training batches.

For the HHORNNs and NHHORNNs that do not suffer from vanishing or exploding gradients, a learning rate of 0.01 was used throughout all experiments, and no gradient scaling was applied. In order to determine the influence of the intrinsic parameters β and ω₀ on the HHORNN performance, either optimal do values were estimated from a data set to be processed using information from the power spectral density of a number of samples together with a grid search for β as discussed further below, or a grid search was performed for each data set, assessing learning performance of a HORNN network with all nodes having the same intrinsic parameters β and ω₀ chosen from a grid. For each dataset, the parameter set belonging to the network with the highest learning performance was taken and this HHORNN network, in which all nodes have the same intrinsic parameters, was named the optimal HHORNN network HHORNNopt. Furthermore, the spread of each of the intrinsic parameters over the set of 10 HHORNN networks with the highest learning performances was determined, thus obtaining their minimal and maximal values over the considered set. Using these minimal and maximal values, Non-Homogeneous HORNN networks were generated in which each node was assigned random values such as βᵢ∈U([βmin, βmax]) and ω₀ᵢ∈U([ω₀min, ω₀max]), where U([a, b]) denotes the uniform distribution over the interval [a, b]. This Non-Homogeneous HORNN network and the optimal HHORNN network HHORNNopt were tested to evaluate the influence of the intrinsic oscillation parameters.

Furthermore, tests with overdamped, critically damped and underdamped networks were performed but they are not of relevance in this context.

The connections wi,j were initially set according to different strategies to also evaluate their influence. The connections wi,j were initially set to random values chosen from a uniform distribution

$$U ( [ - \frac{1}{\sqrt{n}} , \frac{1}{\sqrt{n}} ] )$$

where n denotes the number of DHO cells in the network. Alternatively, weights were chosen according to a Gaussian distribution

$$N ( 0 , \frac{1}{3 n} ) .$$

These different choices did not strongly affect final task performance and learning speed. It is also possible to initially set all connections wi,j to w_{i,j}=1 or all wi,j=0. Furthermore, several instances of networks differing only by their initial weights were trained on the same task and no strong dependence of final task performance on weight initialization was found.

Of course, the choice of the value of the discretization constant has a significant influence on the learning performance. E.g., values between 0.01 and 0.5 were tested (0.01, 0.05, 0.1 0.2, 0.3, 0.4 and 0.5) for MNIST and 0.2 was selected due to the best performance.

Already the HHORNNs vastly outperformed the state of the art RNNs with gated units such as LSTM and GRU with respect to learning speed, absolute performance and noise tolerance at the same number of learnable parameters, particularly in the region of low parameter count.

The NHHORNNs in turn outperformed in all aspects the HHORNNs and consequently even more the state of the art RNNs such as LSTM and GRU.

The inventors could identify several reasons for this gain of function of HHORNNs and NHHORNNs:
(i) the time constants introduced by the discretisation of the damped harmonic oscillator equation act as a smoothing prior in the state space and regularize gradients, making BPTT learning more stable;
(ii) the particular kinetics of the DHOs provide every node with its own memory function which facilitates the encoding of temporal relations and makes the nodes sensitive to the sequence order of inputs;
(iii) the prototypical properties of coupled DHOs allow for dynamic phenomena such as resonance, entrainment, synchronization, phase shifts and desynchronization that permit the generation of high dimensional dynamic landscapes in a state space; and
(iv) the introduction of non-homogenous DHOs, in other words the increase of the heterogeneity of the network, amplifies the effects of (i), (ii) and (iii), thereby allowing such heterogeneous=non-homogeneous HORNNs to respond to the stimuli with more complex, less synchronized patterns.

Reason (iv) even creates a significant above chance level classification of stimuli in the untrained state of the NHHORNNs before any learning/training. Although HHORNNs have such a property, too, the effect is stronger in NHHORNNs. The heterogeneous=non-homogeneous HORNNs project inputs to a high dimensional pre-structured state space even in the untrained state and with randomly selected connections wi,j, which eases the training.

In other words, the learning/training process capitalizes on the initial diversification of the response patterns and requires considerably fewer trials to reach high performance levels.

Regarding reason (i), it is emphasized that the discretization with time constant τ does not affect the hardware implementation. The discretization is merely a tool to enable numerical calculation of a model and thus training via BPTT, irrespective of whether the HHORNN or NHHORNN is implemented in hardware or software. The HHORNNs and NHHORNNs and any of its constituting cells turn any input signal into an oscillation, in hardware and in software. Digital signals such as, e.g. delta pulses are turned into analogue signals, and these analogue signals (oscillations) make the resonance phenomena stronger. This fact results from the design of the HHORNNs and NHHORNNs, is inevitably inherent in its hardware and software implementations and is independent of the discretization with time constant τ that only serves efficient training.

The above-described introduction of delay in the connections wi,j increases the heterogeneity and, for the same reason as described with respect to the different preferred frequencies of the DHOs, promotes the overall performance. As a possible rule for the initial setting of such delays, it is possible to introduce a scatter of the coupling delays around a median that corresponds approximately to 1/5 of the cycle duration of the median of the preferred oscillation frequencies. However, this is only a non-limiting example. Other distributions of delay values like e.g. an even delay value distribution between zero delay and 20 times the time series interval ti1 and others are possible as well. The introduction of delays has two effects, first it increases the heterogeneity and second, it introduces a potential reaction delay of the network, which can be considered as a potential retardation interval before providing the output and may represent a kind of intermediate processing result.

The following explanation may provide clues for a better understanding of consequences of the selection and distribution of the natural frequencies of the DHOs. Each DHO is effectively a band pass filter with a “receptive field” defined by the resonant frequency window in which amplitude amplification occurs (see FIG. 5B). A single, isolated DHO cell of the HHORNN/NHHORNN without feed-back connection can be thought of as generating a convolution of the input signal over time and acts as a band pass filter with selective amplification of signals around its natural frequency ω by means of resonance. When a self-connection is present as possible and foreseen in the HHORNNs/NHHORNNs by the potential connection wi,i, an adjustment of the gain of the self-connection allows for shifting the natural frequency ω to a certain extent. In other words, a DHO with self-connection can to a certain extent tune into the input and by means of changing the value of wi,i, can change its receptive field over the course of learning.

As discussed above, the input used for training as well as for probing performance can be pulse inputs or analogue inputs like oscillatory inputs in a narrow sense, irrespective of whether the HHORNNs/NHHORNNs are implemented in hardware or software. The HHORNNs and NHHORNNs of the present teachings will work with both discrete inputs or analogue oscillatory inputs.

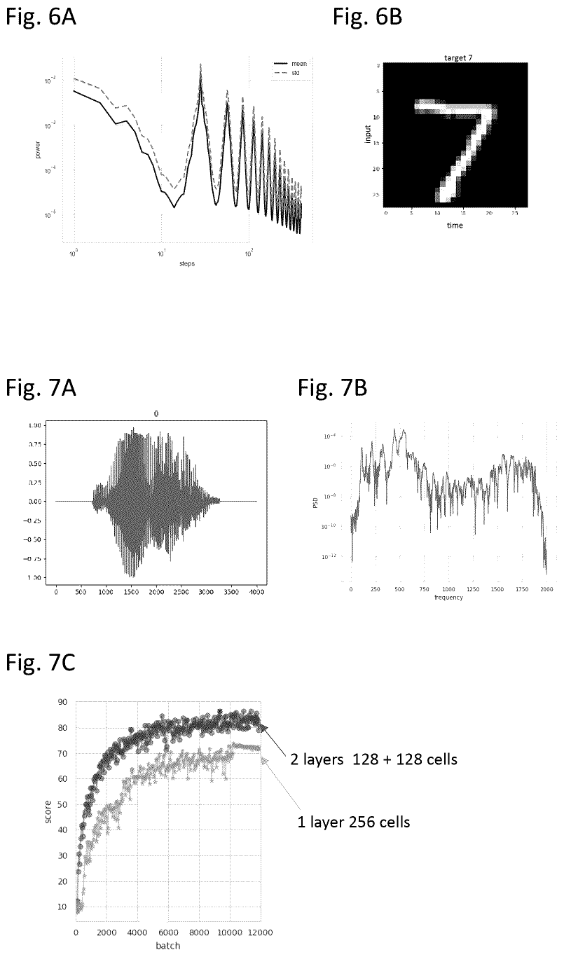

As already described above, if a data set has a pronounced structure such as, for example the MNIST data, it is possible to pre-tune the cells to characteristic frequencies, where the best results are obtained if the resonance frequencies are set at the peaks in the variance, because this allows the network to resonate to the differences of the input signal, i.e., to the stimuli. FIG. 6A shows the variance of the power spectral densities of the MNIST data for the number 7 shown in FIG. 6B, which are time-series input data S (t) of the MNIST data set consisting of 28 by 28 intensity values of the number 7 turned (transformed) into a time-series data D of length TI1=784 by collecting the pixels of each digit in scanline order from top left to bottom right as described above.

In such a MNIST data set, a vertical line has a period of 28, a line at 45 degrees inclination has a period of 27 or 29, etc. This period is “translated” into frequencies via an input time interval.

This example also helps to understand the different strategies to select the characteristic frequencies of the DHOs. It is possible to select high resonance at precisely selected frequencies, if there is a pronounced structure in the data to be processed, or, if there is no pronounced structure, a broader tuning can be selected.

In the following, the design and effectiveness of multi-layered HHORNNs/NHHORNNs is explained.

Using speech data, the performance was tested with spoken digits. The “Free Spoken Digit Dataset” consisting of 3000 samples of spoken digits 0 to 9 was used, with each sample representing 1 second of recorded audio recorded at an 8000 Hz sampling rate in mono, and sub-sampled to 4000 Hz. The 3000 samples represent spoken digits by 6 male speakers with 50 samples per speaker per digit. This approach results in a relatively small (and thus harder to learn) data set of 3000 samples. 10% of these data were used as test data, in other words 300 samples, while 90% of these data were used for training.

FIG. 7A shows the waveform of one sample of 1 second in length, and FIG. 7B shows the variance of the power spectral densities computed across the power spectral densities of 1000 samples.

The amplitude values were directly fed as time-series data to the networks, in other words as a 4000-dimensional vector.

The network size of a first NHHORNN trained and fed with the data was n=256 cells, with the cells arranged in one layer with all-to-all connectivity.

A second NHHORNN with n=256 cells, but structured in two layers, was given the same task, i.e., trained and fed with the same data. The second NHHORNN was divided into a first layer with n₁=128 cells and a second layer with n₂=128 cells.

Before describing the layers and the initial set up in detail, some definitions for describing multi-layered HHORNNs/NHHORNNs are given. Let's assume a two-layered network with n cells in total, of which n1 cells are in the first layer, which receives the input signal and is thus the upstream layer in respect of the overall input-output direction, and of which n2 cells (n=n1+n2) are in the second layer, which is downstream in respect of the overall input-output direction, and only cells of the second layer are connected to provide the output signal.

All-to-all connectivity within one layer means the same as with the previously described one-layered networks.

Forward connection/connectivity means a connection wi,j between the input/output node IOᵢ of at least one of the n1 cells nci of the upstream (e.g. first) network layer and the input/output node (IOⱼ) of at least one of the cells ncj of the downstream (e.g. second) network layer for transmitting the resulting damped harmonic oscillation hᵢ output from the node IOᵢ of at least one of the n1 cells nci of the upstream (e.g. first) network layer to the input/output node (IOⱼ) of at least one of the n2 cells (ncj) of the downstream network layer.

Feedback connection/connectivity means a connection wj,i between the input/output node IOⱼ of at least one of the n2 cells ncj of the downstream (e.g. second) network layer and the input/output node (IOᵢ) of at least one of the cells nci of the upstream (e.g. first) network layer for transmitting the resulting damped harmonic oscillation hⱼ output from the node IOⱼ of the at least one of the n2 cells ncj of the downstream (e.g. second) network layer to the input/output node (IOᵢ) of the at least one of the n1 cells (nci) of the upstream network layer.

A maximum/minimum forward connectivity of X/Y % means that a maximum or minimum of X % of the input/output nodes of 100% of the n1 cells nci of the upstream network layer is potentially connected to the input/output nodes of a maximum or minimum of Y % of the input/output nodes of 100% of the n2 cells ncj of the downstream network layer for transmitting the resulting damped harmonic oscillations hᵢ output from the corresponding input/output nodes of the n1 cells nci of the upstream network layer to the input/output nodes IOⱼ of the n2 cells ncj of the downstream network layer. Correspondingly, a maximum/minimum feedback connectivity of X/Y % means that a maximum or minimum of X % of the input/output nodes of 100% of the n2 cells ncj of the downstream network layer is potentially connected to the input/output nodes of maximum or minimum of Y % of the input/output nodes of 100% of the n1 cells nci of the downstream network layer for transmitting the resulting damped harmonic oscillations hⱼ output from the corresponding input/output nodes of the n2 cells ncj of the downstream network layer to the input/output nodes IOᵢ of the n1 cells nci of the upstream network layer. Accordingly, if corresponding maximum/minimum forward or feedback connectivity is given as N/M such 32/64, the corresponding maxima and minima are integer numbers and not percentages.

Potentially connected means that the matrix W in equations (9) or the matrices Wₖ in equations (10) include corresponding matrix elements wi,j that can be different from 0, even if, as a result of the training, the corresponding element may finally be set to 0. Correspondingly, in hardware implementations, a corresponding connection element wi,j is present that can be set to the corresponding transmission characteristic T_{i,j}=w_{i,j}×hᵢ with w_{i,j}∈R and |w_{i,j}|≤10 as a result of the training.

The preferred frequencies of the DHOs in the first layer of the second NHHORNN were set as in the first one-layered NHHORNN, namely to be distributed over the frequency range of the input data of the variance of the power density spectrum of the input data. In the second NHHORNN, the preferred frequencies of the DHOs of the second layer were set to be lower than those of the first layer, namely the resonance frequencies in the second layer were set to 1/5 (20%) of the resonance frequencies of the first layer. Other choices are possible such as 1/2, 1/3, 1/4, 1/6, 1/8, 1/10 or 1/20 of the resonance frequencies. Preferred frequencies of the DHOs of the second layer may also be higher than the ones in the first layer, such as 2, 3, 4 or 5 times the resonance frequencies of the first layer.

In the second 128+128 NHHORNN, the 128 cells in the first layer had all-to-all connectivity between the 128 cells (=100% forward and 100% feedback and self-connectivity within the layer), the 128 cells in the second layer had all-to-all connectivity between the 128 cells (=100% forward and 100% feedback and self-connectivity within the layer), and the forward connectivity of the cells of the first layer was set to 100%, and the feedback connectivity of the cells of the second layer was set to 50%, in other words 100% feedforward connectivity and 50% feedback connectivity between the two layers.

The increase in performance between the one-layer NHHORNN and the two-layer NHHORNN having the same number of cells is shown in FIG. 7C. One of the reasons for this increase in performance is that the lower resonance frequencies of the second layer serve as a low pass filter and suppress the high-frequency components in the activity patterns of the first layer. These high-frequency components are usually due to input signals that are uncorrelated and therefore impair rather than support classification. Accordingly, the already significantly increased performance of one-layered NHHORNNs can be further increased by multi-layered NHHORNNs without increasing the number of cells, if the tasks become more complex and require more cells.

The NHHORNNs comprise in general a plurality of n cells with n≥8. The cells may be connected in an all-to-all connectivity, but for larger numbers n of cells, such an all-to-all connectivity does not bring enough increase in performance versus the exploding complexity of the connections. Therefore, all-to-all connectivity is limited preferably to groups or sub-groups of na cells with na≤512, preferably na≤256, more preferably na≤ 128, even more preferably to na≤64 or na≤32 or na≤16 or na=9 or na=4, if n exceeds 512.

As discussed with respect to the above 128+128 two-layer NHHORNN, from a certain number of cells onwards, it is more effective to structure two or more layers of the network rather than increase the number of cells in a one-layer network. Alternatively or in combination, it is also effective to limit the number of connections within the same network layer. In addition, it may be preferable to provide more feedforward connections from an upstream layer to a downstream layer than feedback connections from the downstream layer to the upstream layer. In addition, it may be advantageous to set the parameters ω₀ᵢ=natural frequency of the undamped oscillations of the damped harmonic oscillators of the cells of the downstream network layer such that the highest natural frequency of the cells of the upstream network layer is higher than the highest natural frequency of the cells of the downstream network layer and the lowest natural frequency of the cells of the upstream network layer is higher than the lowest natural frequency of the cells of the downstream network layer. Preferably, the natural frequencies in the downstream network layer are set to frequencies of 20% to 80% of the frequencies in the upstream network layer, more preferably 20% to 50% such as 20% or 30% or 40% or 50%.

For example, a first plurality of n1 cells is arranged in a first network layer L1, in which at least one of the cells is connected to the input unit and which is thus the most upstream layer in terms of forwarding data and processing results, and a second plurality of n2 cells is arranged in a second network layer L2, in which at least one of the cells is connected to at least one of the cells of the first layer and is therefore more downstream than the upstream (first) layer in terms of forwarding data and processing results. Of course, optionally third, fourth, fifth, sixth, . . . x-th layers (x≤1000) can be added with n3, n4, n5, n6, . . . nx cells.

In particular, if the data to be processed have potentially strong interrelations between neighboring data points and potentially weak interrelations between distant data points such as in 2D image data, a possibly effective setup for designing a two layer network is the introduction of many connections wi,j between smaller groups of DHOs in the first (upstream) network layer such as all-to-all connectivity within a smaller group and fewer connections wi,j between these smaller groups of DHOs in the first (upstream) network layer resulting in 25% to 75% potential connections between the cells of the different smaller groups. The second (downstream) layer may have the same number of cells as the first layer or a smaller number. The number of feedforward connections from the cells of first (upstream) layer L1 to the cells of second (downstream) layer L2 is preferably higher, e.g. by 25% or 50% or 75% or 100% or 125% or 150% than the number/percentage of feedback connections from the cells of second (downstream) layer L2 to the cells of first (upstream) layer L1. The same applies if a third, more downstream layer is added, etc.

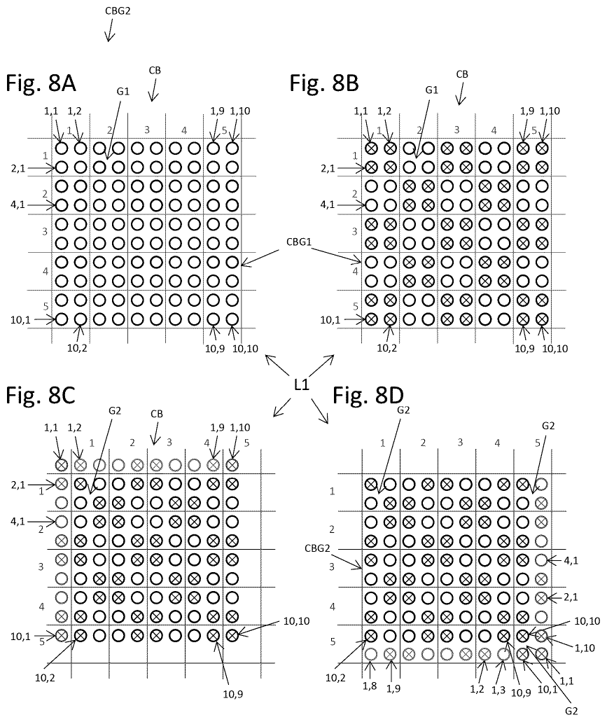

One example for such a two-layer network is described in FIGS. 8A-D and 9.

In FIG. 8A, n1=100 cells are shown to be arranged in a 10×10 matrix CB. The cells can be indexed in rows k and columns 1 with k, 1=1, 2, . . . , 5, i.e., with k, 1. The matrix CB is only shown to explain the organization and connections of the cells and does not imply that a hardware implementation requires a physical arrangement of the cells in a matrix CB. A 5×5 chessboard pattern CBG1 is shown grouping the 100 cells into 25 first groups G1 of 4 cells each. In FIG. 8B, the 4 cells in each of the 25 first groups G1 are marked alternatingly in rows and columns with a cross in every second group merely to ease identification of the cells in the first groups. The recurrent connection unit comprises connections for all-to-all connectivity for all cells in each of these 25 first groups G1.

FIG. 8C shows the 5×5 chessboard pattern CBG2 which is shifted by 1 cell in the row direction and 1 cell in the column direction in comparison to CBG1, in other words by 50% of the cells in one first group in both directions. This shift is used to create 25 second groups G2 of 4 cells each as follows: The shift creates a new set of 16 second groups G2 with 4 cells each, where each of the 4 cells was part of a different group of first groups G1. At the edges of the matrix CB, there are only two cells per “group” created by shifting the chessboard pattern, and at the four corners of the matrix, there is only one cell per “group” created by shifting the chessboard pattern. In order to organize the 100 cells in 25 second groups G2 with 4 cells each created by shifting the chessboard pattern, the 8 second groups G2 at the edges of the matrix in the shifting directions are “filled up” with the two remaining cells from the first groups G1 on the diagonally opposite sides/edges of the matrix, which are not included in one of the 16 second groups G2 already completed with 4 cells. And the second group G2 at the corner of the matrix in the shift directions including only one cell (10,10), is filled up with the 3 cells (1,1, 1,10 10,1) from the other three corners of the matrix. The corresponding second grouping is shown in FIG. 8D. The recurrent connection unit comprises connections for all-to-all connectivity for all cells in each of these 25 second groups G2.

This organization provides many connections wi,j between the cells/DHOs of the first groups G1 in the first (upstream) network layer L1, such as in the described case all-to-all connectivity within the 25 first groups G1, and fewer connections wi,j between the first groups G1 of cells/DHOs in the first (upstream) network layer L1, namely 25% to each of the “neighbouring” first groups G1 by the second grouping and the all-to-all connectivity in the second groups G2 each including 4 (=25%) cells from four different first groups G1.

Of course, the above organization of the first network layer L1 is not limited to 10×10=100 cells grouped in 5×5=25 groups. The number g1 of cells per group can be any square of an integer with divider 2≤256, namely, 4, 16, 36, 64, . . . , 256 and the grouping can be any grouping in a (u×v) matrix with u, v=u, v=2, 3, 4,5,6, . . . provided that the product (g1 u v)≤nmax such as 102400. In this description, we only discuss square matrix organizations (u=v) although the principle is equally applicable to rectangular organizations (u≠v). The limit of g1≤256 is especially selected to limit the complexity of the connections in case of all-to-all connections. The above described organization by “chessboard pattern shifting” and following assignment to incomplete groups via diagonal assignment and grouping the 4 corners works to complete the second grouping for all these organizations of groups and provides the intended connection diversity within the first (upstream) layer.

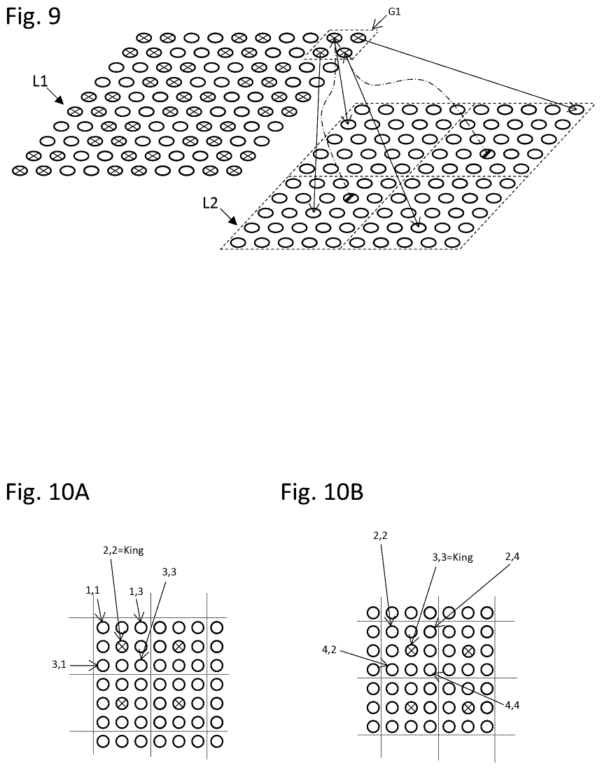

The two-layered HORNN of FIG. 9 comprises the first (upstream) layer L1 described with reference to FIGS. 8A-D and a second (downstream) layer L2 having n2 of the n cells with 8≤n2. In the example of FIG. 9, the second (downstream) layer L2 comprises the same number n2=n1 of cells as the first (upstream) layer, which is only a non-limiting example to explain the principles.

As with all of the multi-layer RRNs of the present teachings, it is in general possible to implement each of the layers as a HHORNN or as an NHHORNN. That means that the DHOs within one layer of the multi-layer network may be implemented with identical intrinsic parameters β and ω₀ as a HHORNN layer or with potentially different parameters βᵢ and with at least some different parameters ω₀ᵢ as an NHHORNN layer. This fact is not mentioned again every time for each example of multi-layered RNNs of the present teachings.

The recurrent connection unit RCU comprises at least one feedforward connection wi,j between at least one of the input/output nodes IOᵢ of the cells nci of each first group G1 of the first network layer L1, in the shown example one feedforward connection wi,j between the input/output nodes IOᵢ of each of the cells nci of each first group G1 of the first network layer L1, and the input/output node IOⱼ of at least one of the cells ncj of the second network layer L2 for transmitting the resulting damped harmonic oscillation hᵢ output from the input/output node of the one corresponding cell nci of the first network layer to the input/output node of the corresponding one of the cells ncj of the second network layer, and at least one feedforward connection wi,j between the input/output node IOᵢ of one of the cells nci of each second group G2 of the first network layer and the input/output node IOⱼ of at least one of the cells ncj of the second network layer L2 for transmitting the resulting damped harmonic oscillation hᵢ output from the input/output node of the corresponding cell nci of the first network layer to the input/output node of the corresponding one of the cells ncj of the second network layer (for the shown example this follows naturally because the input/output nodes IOᵢ of each of the cells nci of each first group G1 of the first network layer L1 are connected and thus inevitably also one cell of the corresponding second group G2), and at least one feedback connections wj,i to the input/output node IOᵢ of one of the cells nci of each first group G1 of the first network layer from the input/output node IOⱼ of a corresponding number of the cells ncj of the second network layer L2 for transmitting the resulting damped harmonic oscillation hᵢ output from the input/output node of the corresponding cells ncj of the second network layer L2.

The parameters ω₀ᵢ=natural frequency of the undamped oscillations of the damped harmonic oscillators of the n2 cells of the second network layer are set such that the highest natural frequency of the n1 cells of the first network layer is higher than the highest natural frequency of the n2 cells of the second network layer and optionally that the lowest natural frequency of the n1 cells of the first network layer is higher than the lowest natural frequency of the n2 cells of the second network layer. This setting will have the result that the second network layer acts as a kind of low pass filter for the signals/oscillations transmitted from the first network layer, thereby suppressing potentially unrelated high frequency components and thus improving the performance of the corresponding HHORNNs/NHHORNNs.

The arrangement of sub-groups of the cells with all-to-all connectivity in the layers is also not limited to the above-described chessboard pattern arrangement. For example, the well known King's graph arrangement deduced from the possible movements of the King in the chess game could be used. Such an arrangement is shown in an exemplary manner in FIGS. 10A-B as a third embodiment, in which the cells are arranged in an assumed (or real) matrix arrangement in rows and columns and one cell, in the example the cell 2,2 (=King) is all-to-all connected to eight “neighbour cells”, namely the one cell in the same column in the row above (cell 1,2) and its two direct neighbours (cells 1,1 and 1,3) in the row above, the one cell (cell 3,2) in the same column in the row below in its two direct neighbours (cells 3,1 and 3,3) in the row below, and the two direct neighbours (cells 2, 1 and 2, 3) in the same row as shown in FIG. 8A. FIG. 8B shows the King's graph arrangement for cell 3,3 as the “King”, with all-to-all connectivity to the 8 neighbouring cells 2,2, 2,3 2,4, 3,2, 3,4, 4,2, 4,3 and 4,4.

Network of the types shown in FIGS. 8A to 10B and other modified networks can be implemented in layered structures with 2,3, 4, 5, 6, 7, 8, . . . , x layers (x≤1000). If there are more than two layers, there can be layer skipping connectivity/connections. Particularly useful is layer skipping feedback connectivity from more downstream layers to more upstream layers skipping one or more of the intermediate upstream layers such as, in a 4-layered network from the 4th (most downstream) layer to the 2^{nd} or 1^{st} layer skipping the 3^{rd} or the 3^{rd} and 2^{nd} layers. Such skipping feedback connections help to refeed intermediate recognition “results” to establish a structure in which intermediate recognition results trigger activation of specific areas in the network. Such layer skipping feedback enhances the possibilities of resonance, entrainment, synchronization, phase shifts and desynchronization.

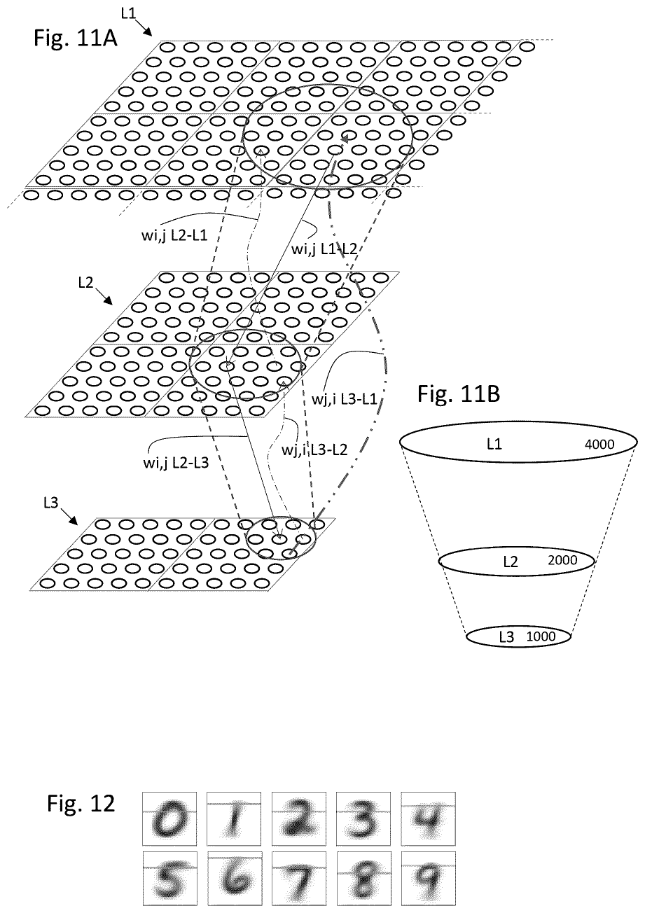

A schematic example of a network including layer skipping feedback connectivity is shown in FIG. 11A, where three layers L1, L2, L3 are present. The layers may be of the same or different types of layers (HHORNN or NHHORNN) and/or may have the same or different connectivity within the different layers. For example, the most upstream layer L1 could be implemented as a HHORNN with all-to-all connectivity in the King's graph arrangement of FIGS. 10A-B within the first layer L1, the second layer L2 could be implemented as an NHHORNN with all-to-all connectivity in the chessboard arrangement of FIGS. 8A-D within the second layer L2, and the most downstream (third) layer L3 could be implemented as an NHHORNN with all-to-all connectivity in the King's graph arrangement of FIGS. 10A-B in separate groups of 100 cells each within the third layer L3. There is feedforward connectivity (wi,j, L1-L2 and wi,j L2-L3) and feedback connectivity (wj,i L3-L2 and wj,i L2-L1) between the adjacent layers, for example with increased connectivity between selected areas of cells in the first layer L1 and selected areas of cells in the second layer L2 and between selected areas of cells in the second layer L2 and selected areas of cells in the third layer L3 as schematically indicated in FIG. 11A, and there is layer skipping feedback connectivity as indicated in FIG. 11A by the connection wj,i L3-L1 between the third layer L3 and the first layer L1.

With such arrangements limiting the all-to-all connectivity to sub-groups of cells as described above, the number of cells per layer can be increased very much without exploding complexity of the connections in software or hardware. Networks having 100000 cells or more in the most upstream layer become possible, and 10000 cells per layer are no problem, if the complexity of the tasks requires such extension. In FIG. 11B, the three-layered network of FIG. 11A is schematically shown with 4000 cells in the first layer L1, 2000 cells in the second layer L2 and 1000 cells in the third layer L3 to exemplify the same.

If the information to be processed are of a geometric nature such as image data or more generally express spatially invariant statistics, it can be advantageous to use HHORNNs as the first layer L1 on the input side. The reason is that the first layer L1 of the network can process, as a result, the input in a spatially invariant way.

In the following, it is explained how an implementation of an NHHORNN in semiconductor hardware can be made to set to the connection values and potential time delays after the network has been trained with the BPTT technique.

It is assumed that a number n of 1296 oscillators DHOi is arranged in a 36×36 matrix array on a semiconductor chip in conventional CMOS technology. Each of the oscillators DHOi is implemented e.g. as a ring oscillator in CMOS. The oscillators DHOi are all-to-all connected in the King's graph arrangement as described above in FIGS. 8A-B. The connection weights of the connections are set by multi-stage transmission gate coupling blocks providing the connections wi,j between the oscillators DHOi and DHOj. Such a multi-stage transmission gate coupling block may be implemented as shown in FIG. 2 of PA2. The coupling value of such a multi-stage transmission gate coupling block is set by the values stored in a memory implemented as SRAM, if the coupling weights should be reprogrammable, or as ROM, if not. A corresponding exemplary arrangement with SRAM is shown in FIGS. 2 and 3 of PA2. Of course, this reference to PA2 is only a non-limiting example and a memory block controlling the amplification of CMOS implemented amplifiers for continuous setting of connection values can be used, wherein the potential reversal of the sign of the connection value is implemented with a single inverter switched into the connection wi,j or not.

The connection delays can be implemented by selecting/setting the number of staged inverters also controlled by corresponding SRAM or ROM memory blocks. If such delays are provided by staged inverters, they can be simultaneously used to set the potential weight inversion.

It is obvious in the above-described case that the non-linear saturating transfer function input element ICSᵢ can be implemented as an input element in CMOS as shown in US 2018/0307977 A1, with a CMOS implemented adder ICAᵢ connected to each input element ICSᵢ.

Such an implementation as CMOS ASIC will provide an extremely low power consumption for the trained HHORNN/NHHORNN.

The training of this CMOS NHHORNN is implemented using the well-known BPTT, and the values for the connection unit can be obtained in this way and then stored in the memory block, either as rewritable values when using a rewritable memory such as an SRAM or, if the final NHHORNN product should be not reprogrammable, in a ROM (or by melting fuses etc.).

The above descriptions of the HHORNNs and of the NHHORNNs with equations (9) or (10) provide a tool to implement the DHOs, their connections and the inputs and outputs, in other words the HHORNNs/NHHORNNs, in software and to run them on a correspondingly programmed data processing device such as a general purpose computer. That means a method of calculating the oscillations performed by the DHOs is implemented by: (i) creating a description of a corresponding RNN using equations (9) or (10) to define output data O (t) in response to input data S (t), (ii) inputting input data S (t) representing data to be processed into the description resulting in a calculation of the oscillations caused by the input data (S (t) which result in the calculation of output data O (t) according to the description and the calculated oscillations, and (iii) outputting a processing result based on the output data resulting from the input data. The equations (9) or (10) capture, if no training has been performed, the initial setting of an RNN. In this case, the description can be used for training. If the training result is used to create the description of the RNN, the created description represents the trained RNN and thus a data processing tool providing the processing results of recognizing the objects/events represented by the corresponding input data S (t). Accordingly, a computer program including program code, which implements, when run on a correspondingly programmed computer, the above described method, is one possible implementation of the HHORNNs/NHHORNNs of the present teachings.

The output data will often provide the processing result before all input data S(t) are input. For example, a 16 cell NHHORNN with all-to-all connectivity including self-connectivity trained for the MNIST data was always certain about the digit to be recognized with less than 50% input of the total input data S(t). FIG. 12 shows all 10 digits with a line representing the input data already input from the top of the image, when the RNN was certain about the result.

The HHORNNs and NHHORNNs were also very resilient to introduction of noise into the input data S(t) and also in this respect outperformed state of the art RNNs.

The recurrent neural network and the data processing method and devices of the present invention can be used, e.g., for diverse data processing tasks, which are challenging for state of the art techniques.

One first example is image segmentation and classification, such as detecting objects in digital images, or segmenting an image into a set of objects contained in the image. In the state of the art, this task is often implemented by using feed forward neural networks, i.e. networks that have one input layer, intermediate layers and an output layer (deep neural networks). Examples are the Multilayer Perceptron, Convolutional Neural Networks, or Transformer networks. Using the intermediate layers, the network transforms the input pixel values into a representation suitable to solve a classification/detection/segmentation task, e.g. detecting traffic signs in a self-driving (autonomous) car. With the recurrent neural networks/data processing devices of the present teachings, a new, radically different approach is possible. A HORNN (both types NHHORNN and HHORNN) is recurrent in nature and receives the input as a time series. The network is implemented with several layers: as a first layer a geometrically organized HHORNN, followed by one HHORNN or NHHORNN layer, which is either geometrically organized or all to all, or a combination thereof. Geometrically organized means a connection structure (connectivity) within the layer with a limited number of connections to other cells which can be considered as next neighbors and thus as a geometric pattern such as the King's graph or the chessboard pattern described above or other corresponding next neighbor connection patterns. To present an image to the network, a matrix of n×m pixel values (each pixel having an intensity value between v_min and v_max, potentially for different color channels R, G, B) is turned into a time series of length N by sweeping the domain of values [v_min, v_max] from top to bottom (or from bottom to top) in discrete steps v_1=v_max, . . . , v_N=v_min. This yields a time series of length N where each time point is represented by a n×m matrix M_i (1≤i≤N), and the entries of M_i are set to 1 where the corresponding pixel value passed the threshold v_i, and 0 everywhere else. In other words, the topography of the n×m pixel values is sampled into N n×m matrices. The cells of the first layer of the network are stimulated according to the values in that time series.

Given some processing time, the network processes the input data. Multiple layers can form more abstract representations of the data, and either can be geometrically organized (respecting geometric organization of input data, or all to all). After some time, the state of the network (answer) is read out. The network can develop internal measures for “knowing” when it has found a good answer to the given input, e.g. by measuring the entropy of the dynamic state.

We note that the type of processing described in the first example is not limited to image data that possesses inherent spatial relationships, but can also be applied in the same way to other spatially organized data (such as sensor data obtained from spatially distributed sensors).

A second example is keyword spotting. Keyword spotting deals with the identification of keywords in utterances such as detecting the presence of wake words (“Hey, Siri”, “Okay, Google”) in a constant stream of recorded audio, e.g. for the purpose of smart devices (smart watch, smart phone, smart speaker) to go into a mode in which it accepts commands.

In the state of the art, this task is often implemented in that microphone data (sound pressure levels) are recoded, digitized, chunked, MFCC extraction (described in de.wikipedia.org/wiki/Mel_Frequency_Cepstral_Coefficients) is performed, mapping to feature vectors is performed and then the sequence of feature vectors are fed to a detection/classifier unit (e.g. a recurrent neural network) to detect whether a keyword was detected in the audio recorded. An example procedure is shown in: github.com/MycroftAI/mycroft-precise#how-it-works. Software implementations are given in: github.com/Picovoice/porcupine, and github.com/MycroftAI/mycroft-precise. With the recurrent neural networks/data processing devices of the present teachings, a new, radically different approach is possible, namely to feed the raw microphone data (sound pressure level) directly into a correspondingly trained NHHORN.

A third example is speech recognition. In the state of the art, this task is often implemented similar to the keyword spotting in that microphone data (sound pressure levels) are recoded, digitized, chunked, MFCC extraction (described in de.wikipedia.org/wiki/Mel_Frequency_Cepstral_Coefficients) is performed, mapping to feature vectors is performed and then the sequence of feature vectors are fed to a detection/classifier unit (e.g. a recurrent neural network, SVM, . . . ) to detect a sequence of words. Using information from a language model, likely sequences of words (e.g. sentences) are output. With the recurrent neural networks/data processing devices of the present teachings, a new, radically different approach is possible. Raw microphone data (sound pressure level) is fed without any pre-processing into a (correspondingly trained) multi-layer NHHORN. The nature of the NHHORNN provides for a potential tonotopic organization of the first layer, i.e., that cells coding for similar frequencies are more likely to be connected during training and therefore are connected during training, leading to a “geometric” organization of frequency space. Therefore, over the course of several layers, the network is able to form abstract representations of the input data, allowing for, e.g., transcribing syllables, words, sentences.

A fourth example is anomaly detection, i.e., identification of rare events in time series data which deviate from expected or normal behaviour (as defined from the majority of the data). In the state of the art systems, this task is implemented by using different approaches from simple statistical tests to neural networks based methods: en.wikipedia.org/wiki/Anomaly_detection. With the recurrent neural networks/data processing devices of the present teachings, a new, radically different approach is possible. It is now possible to directly feed time series data value by value into a (correspondingly trained) HHORNN/NHHORNN, potentially multi-layered. Examples are simple tasks like EKG, EEG, MEG or other time series data from organisms, machines or processes. With the HHORNN/NHHORNNs it is not necessary to chunk the data or the like.

A fifth example is closed loop or feedback control. A closed loop or feedback control system is a system which aims at maintaining a prescribed relationship between two sets of system variables by comparing functions of these variables and using the difference as a means of control (en.wikipedia.org/wiki/Control_theory). Example applications are e.g. controlling chemical reactions (by means of controlling valves) or direction control of moving objects etc. With the recurrent neural networks/data processing devices of the present teachings, a new, radically different approach is possible. It is now possible to directly feed time series data representing measured variables into a (correspondingly trained) potentially multi-layered HHORNN/NHHORNN trained to predict the dependent variables.

A sixth example is time series prediction and predictive analytics. Given historical values of a time series (e.g. sensor data), the task is to predict the development of the data in the future (en.wikipedia.org/wiki/Predictive_analytics). With the recurrent neural networks/data processing devices of the present teachings, a new, radically different approach is possible. It is now possible to directly feed time series data value by value into a (correspondingly trained) HHORNN/NHHORNN, potentially multi-layered.

The above teachings also can be implemented as stated in the following aspects of the present disclosure:

Aspect 1. A recurrent neural network for processing the time-series input data (S (t)), comprising
a plurality of n damped harmonic oscillators (DHOi, i=1 to n), n≥8, the oscillation of each of which follows the general second order differential equation for damped harmonic oscillators of xᵢ(t):xᵢ(t)+βᵢxᵢ(t)+ω₀ᵢ²xᵢ(t)=0 with βᵢ=damping factor and ω₀ᵢ=natural frequency of an undamped oscillation such as βᵢ=cᵢ/2mᵢ and ω₀ᵢ²=kᵢ/mᵢ, mᵢ=mass, kᵢ=spring constant and cᵢ=viscous damping constant for a corresponding damped translatory mechanical harmonic oscillator DHOi, or βᵢ=Rᵢ/Lᵢ and ω₀ᵢ²=1/LᵢCᵢ, Rᵢ=resistance, Lᵢ=inductance and Cᵢ=capacity for a corresponding damped electrical RLC harmonic oscillator DHOi, and the like for other types of damped harmonic oscillators, each of the n damped harmonic oscillators being one cell (nci) of the neural network,
each cell (nci) having an input/output node (IOᵢ) for receiving a cell input (xᵢ) such as a translation of the corresponding damped translatory mechanical harmonic oscillator or an electric input of the corresponding damped electrical RLC harmonic oscillator and for outputting the resulting damped harmonic oscillation (hᵢ),
the input/output node (IOᵢ) comprising
an input connection (ICᵢ) adapted to receive any input to the cell and to output the same via a non-linear, preferably saturating such as sigmoid-like with optional offset or tanh-like, transfer function as the cell input (xᵢ) such as via a viscoelastic input element for a corresponding damped translatory mechanical harmonic oscillator or via a transistor implemented sigmoid input (ICSᵢ) for a corresponding damped electrical RLC harmonic oscillator DHOi, and
an output connection (OCᵢ) adapted to output the resulting damped harmonic oscillation (hᵢ), and
a recurrent connection unit (RCU) comprising, for each of the cells (cᵢ), at least one connection (wi,j) between the input/output node (IOᵢ) of the corresponding cell (nci) and the input/output node (IOⱼ) of at least another one of the cells (ncj) for transmitting the resulting damped harmonic oscillation (hᵢ) output from the input/output node (IOᵢ) of the corresponding cell (nci) to the input/output node (IOⱼ) of the another one of the cells (cⱼ).

2. The neural network according to the above-mentioned Aspect 1, wherein the at least one connection (wi,j) between the input/output node (IOᵢ) of the corresponding cell (nci) and the input/output node (IOⱼ) of the another one of the cells (ncj) of the recurrent connection unit (RCU) is set to a transmission characteristic T_{i,j}=w_{i,j}×hᵢ with w_{i,j}∈R and |w_{i,j}|≤10, which connection (wi,j) can be, for example, a viscous element for transmission of the output (hᵢ) of a corresponding damped translatory mechanical harmonic oscillator or an electric voltage divider or a transmission gate coupling for transmission of the output (hᵢ) of a corresponding damped electrical RLC harmonic oscillator.

3. The neural network according to the above-mentioned Aspect 1 or 2, wherein the at least one connection (wi,j) between the input/output node (IOᵢ) of the corresponding cell (nci) and the input/output node (IOⱼ) of the another one of the cells (ncj) of the recurrent connection unit (RCU) is set to a transmission characteristic T_{i,j} and delays the transmission by an output time delay ∂t_{i,j}=k_{i,j}×Δt, k_{i,j}=0, 1, . . . , k, 0≤k≤kmax, ti1/10≤Δt≤ti1 and k_{i,j}×Δt≤50 ti1, where ti1 is a time series interval of the time-series input data (S (t)) representing either the time interval between subsequent discrete values in case of discrete time-series input data (S (t)) or the time interval between subsequent sampling values of continuous time-series input data (S (t)), which output time delay can be, for example, an elastic element for transmission of the output (hᵢ) of a corresponding damped translatory mechanical harmonic oscillator or an electric inductivity or a clocked output gate for transmission of the output (hᵢ) of a corresponding damped electrical RLC harmonic oscillator.

4. The neural network according to any preceding Aspect, wherein the recurrent connection unit (RCU) comprises for at least one of the cells (cᵢ) a connection of the input/output node IOᵢ of the corresponding damped harmonic oscillator DHOi to itself for input and for output, providing self-connectivity, and preferably the recurrent connection unit (RCU) comprises connections for self-connectivity for 5%, more preferably 10%, more preferably 25%, more preferably 50%, more preferably 75%, and more preferably 100% of the cells.

5. The neural network according to any preceding Aspect, wherein a plurality of n1 cells of the n cells with 8≤n1 and with n1<n, are arranged in one (first) network layer (L1) and the recurrent connection unit (RCU) comprises, for each of the n1 cells (cᵢ), at least one connection (wi,j) between the input/output node (IOᵢ) of the corresponding cell (nci) of the one (first) network layer (L1) and the input/output node (IOⱼ) of at least another one of the cells (ncj) of the one (first) network layer (L1) for transmitting the resulting damped harmonic oscillation (hᵢ) output from the input/output node (IOᵢ) of the corresponding cell (nci) to the input/output node (IOⱼ) of the another one of the cells (cⱼ).

6. The neural network according to any preceding Aspect, wherein:
a plurality of n2 of the n cells with 8≤n2 and preferably n2≤n1, are arranged in a second (downstream) network layer (L2) and the recurrent connection unit (RCU) comprises, for each of the n2 cells (cᵢ), at least one connection (wi,j) between the input/output node (IOᵢ) of the corresponding cell (nci) of the second network layer (L2) and the input/output node (IOⱼ) of at least another one of the cells (ncj) of the second network layer (L2) for transmitting the resulting damped harmonic oscillation (hᵢ) output from the input/output node (IOᵢ) of the corresponding cell (nci) to the input/output node (IOⱼ) of the another one of the cells (cⱼ), and
the recurrent connection unit (RCU) comprises
feed forward connections (wi,j) between the input/output nodes (IOᵢ) of the n1 cells (nci) of the one (first) network layer and the input/output nodes (IOⱼ) of the n2 cells (ncj) of the second network layer for transmitting the resulting damped harmonic oscillation (hᵢ) output from the input/output nodes of the corresponding cells of the n1 cells (nci) of the one (first) network layer to the input/output nodes (IOⱼ) of the corresponding cells of the n2 cells (ncj) of the second network layer to establish a minimum potential feed forward connectivity of 10% and a maximum potential feed forward connectivity of 100%, and
feedback connections (wj,i) between the input/output nodes (IOⱼ) of the n2 cells (ncj) of the second network layer and the input/output nodes (IOᵢ) of the n1 cells (nci) of the one (first) network layer for transmitting the resulting damped harmonic oscillation (hⱼ) output from the input/output nodes of the corresponding cells of the n2 cells (ncj) of the second network layer to the input/output nodes (IOᵢ) of the corresponding cells of the n1 cells (nci) of the one (first) network layer to establish a minimum potential feedback connectivity of 10% and a maximum feedback connectivity of 100%, and
optionally a plurality of nr of the n cells with r=3 or 4 or 5 or 6 and 8≤nr and preferably nr≤n(r−1), are arranged in an r-th network layer (Lr) and the recurrent connection unit (RCU) comprises, for each of the nr cells (cᵢ), at least one connection (wi,j) between the input/output node (IOᵢ) of the corresponding cell (nci) of the r-th network layer (Lr) and the input/output node (IOⱼ) of at least another one of the cells (ncj) of the r-th network layer (Lr) for transmitting the resulting damped harmonic oscillation (hᵢ) output from the input/output node (IOᵢ) of the corresponding cell (nci) to the input/output node (IOⱼ) of the another one of the cells (cⱼ), and
the recurrent connection unit (RCU) comprises
feedforward connections (wi,j) between the input/output nodes (IOᵢ) of the n(r−1) cells (nci) of the n(r−1)-th network layer and the input/output nodes (IOᵢ) of the nr cells (ncj) of the nr-th network layer for transmitting the resulting damped harmonic oscillation (hᵢ) output from the input/output nodes of the corresponding cells (nci) of the n(r−1) cells (nci) of the n(r−1)-th network layer to the input/output nodes of the corresponding cells of the nr cells (ncj) of the nr-th network layer to establish a minimum potential feed forward connectivity of 10% and a maximum potential feed forward connectivity of 100%, and
feedback connections (wj,i) between the input/output nodes (IOⱼ) of the nr cells (ncj) of the nr-th network layer and the input/output nodes (IOᵢ) of the n(r−1) cells (nci) of the n(r−1)-th network layer for transmitting the resulting damped harmonic oscillation (hⱼ) output from the input/output nodes of the corresponding cells of the nr cells (ncj) of the n(r−1)-th network layer to the input/output nodes (IOᵢ) of the corresponding cells (nci) of the n(r−1)-th network layer to establish a minimum potential feedback connectivity of 10% and a maximum potential feedback connectivity of 100%.

7. The neural network according to any preceding Aspect, wherein:
the recurrent connection unit (RCU) comprises for the plurality of nr cells arranged in the same r-th network layer, with r=1, 2, . . . , 6 and with 8≤nr and with nr≤n, potential connections (wi,j) for either
all-to-all connectivity of each of the cells to at least 8 and at most 512 of the other cells (ncj) of the nr cells (nci) of the same r-th network layer for transmitting the resulting damped harmonic oscillation (hᵢ) output from the input/output node of the corresponding cell (nci) to the input/output node of the corresponding other one of the n1 cells (cⱼ), or all-to-all connectivity in a King's graph arrangement, or
where the cells are arranged in a ((g1/2 u)×(g1/2 v)) matrix CB, g1=4, 16, 36, 64, 100, 144, 256 and u, v=2, 3, 4, 5, 6, . . . and (g1 u v)≤102400, for first groups (G1) of g1 cells, all-to-all connectivity, wherein these first groups (G1) are arranged in a first chessboard arrangement in a (u×v) matrix CBG1, and for second groups (G2) of g1 cells, all-to-all connectivity, wherein these second groups (G2) are arranged in a second chessboard arrangement in a (u×v) matrix CBG2 shifted versus the first chessboard arrangement CBG1 by g1/2 cells in both the line and column directions and wherein the second groups (G2) at the edges of the matrix CB in the shift directions are completed by the cells at the edges of the matrix CB at the diagonally opposing positions not covered by the second (shifted) chessboard arrangement CBG2 and the second group (G2) at the corner in the shift directions is completed with the cells in the three corners of the matrix CB not covered by the second (shifted) chessboard arrangement CBG2.

8. The neural network according to the above-mentioned Aspect 6 or 7, wherein the recurrent connection unit (RCU) comprises for at least one of the cells (cᵢ) of the r-th network layer (Lr) layer potential skipping feedback connections (wi,j) to at least one of the cells (cᵢ) of the (r-s)-th network layer (L(r-s)) with s=2 or 3 or 4 or 5, and preferably at least 10%, more preferably at least 20% potential layer skipping feedback connectivity.

9. The neural network according to any preceding Aspect, wherein the plurality of n damped harmonic oscillators (DHOi, i=1 to n) comprise at least two different types of damped harmonic oscillators, wherein each of the at least two different types of damped harmonic oscillator differs in at least the parameter ω₀ᵢ=natural frequency of an undamped oscillation from the other types of damped harmonic oscillators.

10. The neural network according to any of the above-mentioned Aspects 6 to 9, wherein the parameters ω₀ᵢ=natural frequency of the undamped oscillations of the damped harmonic oscillators of the nr cells of the nr-th network layer with r=2, 3, . . . , 6, are set such that the highest natural frequency of the n(r−1) cells of the n(r−1)th network layer is higher than the highest natural frequency of the nr cells of the nr-th network layer and the lowest natural frequency of the n(r−1) cells of the n(r−1)-th network layer is higher than the lowest natural frequency of the nr cells of the nr-th network layer.

11. The neural network according to any preceding Aspect, wherein at least three different types of damped harmonic oscillators are provided and the parameters ω₀ᵢ=natural frequency of the undamped oscillations of the at least three different types of damped harmonic oscillators are set such that, based on a determination of the power spectral density of a plurality of samples of the time-series input data (S (t)) to be processed and the variance of these power spectral densities, the natural frequencies are distributed over the peaks of this variance with one of the at least three natural frequencies set to correspond to the peak of the variance with the lowest frequency and one of the at least three natural frequencies set to correspond to the peak of the variance with the highest amplitude, and the remaining natural frequencies set preferably to frequencies essentially uniformly distributed between the frequencies of these two peaks of the variance or in a normal distribution with chosen mean and variance.

12. The neural network according to any preceding Aspect, further comprising:
an input unit (IU) connected to the input connection (ICᵢ) of the input/output node of at least one of the cells (nci) and adapted for receiving and inputting time-series input data (S (t)) with a length TI1 to input the input data (S (t)) to input connection (ICᵢ) of the input/output node of the at least one of the cells (cᵢ), and
an output unit (OU) connected to the output connection (OCᵢ) of the input/output node of at least one of the cells (nci) and adapted for outputting output data (O (t)) with an output starting time (OST) set to be a predetermined time interval after the receipt of the start of input of input data (S (t)).

13. The neural network according to any preceding Aspect, wherein the input/output node of each cell (nci) is adapted for outputting the damped harmonic oscillation (hᵢ) in discrete time steps t_{d}=t₀+dτ (τ=discretization time value), ti1/20≤τ≤ti1/2, 2≤d≤20, where ti1 is a time series interval of the time-series input data (S (t)) representing either the time interval between subsequent discrete values in case of discrete time-series input data (S (t)) or the time interval between subsequent sampling values of continuous time-series input data (S (t)).

It is explicitly stated that all features disclosed in the description and/or the aspects and/or the claims are intended to be disclosed separately and independently from each other for the purpose of original disclosure as well as for the purpose of restricting the claimed invention independent of the compositions of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. A neural network device comprising a neural network for processing the time-series input data (S (t)), comprising:
a plurality of n damped electric harmonic oscillators (DHOi, i=1 to n), n≥8, the oscillation of each of which follows the general second order differential equation for damped harmonic oscillators of xᵢ(t):xᵢ(t)+2βᵢxᵢ(t)+ω₀ᵢ²xᵢ(t)=0 with βᵢ=Rᵢ/Lᵢ and ω₀ᵢ²=1/LᵢCᵢ, Rᵢ=resistance, Lᵢ=inductance and Cᵢ=capacity for a corresponding damped electrical RLC harmonic oscillator DHOi, and corresponding βᵢ and ω₀ᵢ² for other types of damped electrical harmonic oscillators, each of the n damped harmonic oscillators being one cell (nci) of the neural network,
each of the cells (nci) having an input/output node (IOᵢ) configured to receive a cell input (xᵢ) of the corresponding damped electrical harmonic oscillator and to output the resulting damped harmonic oscillation (hᵢ),
each of the input/output nodes (IOᵢ) comprising:
an input connection (ICᵢ) configured to receive any input to the cell and to output the said input via a non-linear transfer function as the cell input (xᵢ), and
an output connection (OCᵢ) configured to output the resulting damped harmonic oscillation (hᵢ), and
a recurrent connection unit (RCU) comprising, for each of the cells (cᵢ), at least one connection (wi,j) between the input/output node (IOᵢ) of the corresponding cell (nci) and the input/output node (IOⱼ) of at least another one of the cells (ncj) for transmitting the resulting damped harmonic oscillation (hᵢ) output from the input/output node (IOᵢ) of the corresponding cell (nci) to the input/output node (IOⱼ) of the another one of the cells (cⱼ).

2. The neural network device according to claim 1, wherein each of the cells (nci) has an input/output node (IOᵢ) configured to input the cell input (xᵢ) as an electric input of the corresponding damped electrical harmonic oscillator via a sigmoid transfer function implementing a CMOS inverter stage circuit (ICSᵢ).

3. The neural network device according to claim 1, wherein each of the cells (nci) has an input/output node (IOᵢ) configured to receive all inputs to the cell via an adder (ICAᵢ) configured to add all inputs to the cell and to output the added inputs as an input to a saturating non-linear transfer function implementing a CMOS inverter stage circuit (ICSᵢ) outputting the cell input (xᵢ) as an electric input of the corresponding damped electrical RLC harmonic oscillator.

4. The neural network device according to claim 1, wherein the at least one connection (wi,j) between the input/output node (IOᵢ) of the corresponding cell (nci) and the input/output node (IOⱼ) of the another one of the cells (ncj) of the recurrent connection unit (RCU) is set to a transmission characteristic T_{i,j}=w_{i,j}×hᵢ with w_{i,j}∈R and |w_{i,j}|≤10.

5. The neural network device according to claim 1, wherein the at least one connection (wi,j) between the input/output node (IOᵢ) of the corresponding cell (nci) and the input/output node (IOⱼ) of the another one of the cells (ncj) of the recurrent connection unit (RCU) is set to a transmission characteristic T_{i,j} and delays the transmission by an output time delay ∂t_{i,j}=k_{i,j}×Δt, k_{i,j}=0, 1, . . . , k, 0≤k≤kmax, ti1/10≤Δt≤ti1 and k_{i,j}×Δt≤50 ti1, wherein ti1 is a time series interval of the time-series input data (S (t)) representing either the time interval between subsequent discrete values in case of discrete time-series input data (S (t)) or the time interval between subsequent sampling values of continuous time-series input data (S (t)).

6. The neural network device according to claim 1, wherein:
each of the connections (wi,j) of the recurrent connection unit (RCU) is implemented as a (2p+1)-level transmission gate coupling with a first chain of at least 2 serially connected NOT gates coupled to receive the output of the outputting input/output node and a second chain of at least 2 serially connected NOT gates coupled to the other inputting input/output node and a block of 4p transmission gates connected between the outputs of the NOT gates of the first chain and the inputs of the NOT gates of the second chain with p≤10 such that the transmission weight of the transmission characteristic T_{i,j}=w_{i,j}×hᵢ is w_{i,j}=0, if none of the transmission gates is connected to the inputs and outputs of the NOT gates, w_{i,j}=+w, if 2w transmission gates are connected phase-correct between the outputs of the NOT gates of the first chain and the inputs of the NOT gates of the second chain, and w_{i,j}=−w, if 2w transmission gates are connected phase-shifted between the outputs of the NOT gates of the first chain and the inputs of the NOT gates of the second chain.

7. The neural network device according to claim 1, wherein the recurrent connection unit (RCU) comprises for at least one of the cells (cᵢ) a connection of the input/output node IOᵢ of the corresponding damped harmonic oscillator DHOi to itself for input and for output, providing self-connectivity.

8. The neural network device according to claim 1, wherein n1 cells of the n cells with 8≤n1 and with n1≤n, are arranged in one (first) network layer (L1) and the recurrent connection unit (RCU) comprises, for each of the n1 cells (cᵢ), at least one connection (wi,j) between the input/output node (IOᵢ) of the corresponding cell (nci) of the one (first) network layer (L1) and the input/output node (IOⱼ) of at least another one of the cells (ncj) of the one (first) network layer (L1) for transmitting the resulting damped harmonic oscillation (hᵢ) output from the input/output node (IOᵢ) of the corresponding cell (nci) to the input/output node (IOⱼ) of the another one of the cells (cⱼ).

9. The neural network device according to claim 8, wherein:
n2 of the n cells with 8≤n2 are arranged in a second network layer (L2) and the recurrent connection unit (RCU) comprises, for each of the n2 cells (cᵢ), at least one connection (wi,j) between the input/output node (IOᵢ) of the corresponding cell (nci) of the second network layer (L2) and the input/output node (IOⱼ) of at least another one of the cells (ncj) of the second network layer (L2) configured to transmit the resulting damped harmonic oscillation (hᵢ) output from the input/output node (IOᵢ) of the corresponding cell (nci) to the input/output node (IOⱼ) of the another one of the cells (cⱼ), and
the recurrent connection unit (RCU) comprises:
feed forward connections (wi,j) between the input/output nodes (IOᵢ) of the n1 cells (nci) of the one (first) network layer and the input/output nodes (IOⱼ) of the n2 cells (ncj) of the second network layer configured to transmit the resulting damped harmonic oscillation (hᵢ) output from the input/output nodes of the corresponding cells of the n1 cells (nci) of the one (first) network layer to the input/output nodes (IOⱼ) of the corresponding cells of the n2 cells (ncj) of the second network layer to establish a minimum potential feed forward connectivity of 10% and a maximum potential feed forward connectivity of 100%, and
feedback connections (wj,i) between the input/output nodes (IOⱼ) of the n2 cells (ncj) of the second network layer and the input/output nodes (IOᵢ) of the n1 cells (nci) of the one (first) network layer configured to transmit the resulting damped harmonic oscillation (hⱼ) output from the input/output nodes of the corresponding cells of the n2 cells (ncj) of the second network layer to the input/output nodes (IOᵢ) of the corresponding cells of the n1 cells (nci) of the one (first) network layer to establish a minimum potential feedback connectivity of 10% and a maximum feedback connectivity of 100%.

10. The neural network device according to claim 1, wherein:
the recurrent connection unit (RCU) comprises for the plurality of nr cells arranged in the same r-th network layer, with r=1, 2, . . . , 6 and with 8≤nr and with nr≤n, potential connections (wi,j) for either
all-to-all connectivity of each of the cells to at least 8 and at most 512 of the other cells (ncj) of the nr cells (nci) of the same r-th network layer for transmitting the resulting damped harmonic oscillation (hᵢ) output from the input/output node of the corresponding cell (nci) to the input/output node of the corresponding other one of the n1 cells (cⱼ), or
all-to-all connectivity in a King's graph arrangement, or
where the cells are arranged in a ((g1/2 u)×(g1/2 v)) matrix CB, g1=4, 16, 36, 64, 100, 144, 256 and u, v=2, 3, 4,5,6, . . . and (g1 u v)≤102400, for first groups (G1) of g1 cells, all-to-all connectivity, wherein these first groups (G1) are arranged in a first chessboard arrangement in a (u×v) matrix CBG1, and for second groups (G2) of g1 cells, all-to-all connectivity, wherein these second groups (G2) are arranged in a second chessboard arrangement in a (u×v) matrix CBG2 shifted versus the first chessboard arrangement CBG1 by g1/2 cells in both the line and column directions and wherein the second groups (G2) at the edges of the matrix CB in the shift directions are completed by the cells at the edges of the matrix CB at the diagonally opposing positions not covered by the second (shifted) chessboard arrangement CBG2 and the second group (G2) at the corner in the shift directions is completed with the cells in the three corners of the matrix CB not covered by the second (shifted) chessboard arrangement CBG2.

11. The neural network device according to claim 9, wherein the recurrent connection unit (RCU) comprises for at least one of the cells (cᵢ) of the r-th network layer (Lr) layer potential skipping feedback connections (wi,j) to at least one of the cells (cᵢ) of the (r-s)-th network layer (L(r-s)) with s=2 or 3 or 4 or 5.

12. The neural network device according to claim 1, wherein the plurality of n damped harmonic oscillators (DHOi, i=1 to n) comprise at least two different types of damped harmonic oscillators, wherein each of the at least two different types of damped harmonic oscillator differs in at least the parameter ω₀ᵢ=natural frequency of an undamped oscillation from the other types of damped harmonic oscillators.

13. The neural network device according to claim 19, wherein the parameters ω₀ᵢ=natural frequency of the undamped oscillations of the damped harmonic oscillators of the nr cells of the r-th network layer with r=2, 3, . . . , 6, are set such that the highest natural frequency of the (r−1) cells of the n(r−1)th network layer is higher than the highest natural frequency of the nr cells of the r-th network layer and the lowest natural frequency of the n(r−1) cells of the (r−1)-th network layer is higher than the lowest natural frequency of the nr cells of the nr-th network layer.

14. The neural network device according to claim 1, further comprising:
an input unit (IU) connected to the input connection (ICᵢ) of the input/output node of at least one of the cells (nci) and configured to receive and input time-series input data (S (t)) with a length TI1 to input the input data (S (t)) to input connection (ICᵢ) of the input/output node of the at least one of the cells (cᵢ), and
an output unit (OU) connected to the output connection (OCᵢ) of the input/output node of at least one of the cells (nci) and configured to output data (O (t)) with an output starting time (OST) set to be a predetermined time interval after the receipt of the start of input of input data (S (t)).

15. A method of training the recurrent neural network device according to claim 1, comprising:
a) setting natural frequencies of the plurality of n damped harmonic oscillators (DHOi, i=1 to n);
b) setting initial weights w_{i,j}∈R and |w_{i,j}|≤10 of the connections (wi,j) of the recurrent connection unit;
c) conducting a training sequence by processing a plurality of a plurality of representative samples of time-series input data (S (t)) to be processed;
d) evaluating the results of the training sequence of step c) by comparing the results with expected results;
e) performing a Back-Propagation-Through-Time (BPTT) technique based on result of the training sequence of step c) and adapting the weights w_{i,j} of the connections (wi,j) of the recurrent connection unit based on the BPTT result,
f) repeating steps c) to e) until either
f1) step d) results in that the results comply with the expected results or
f2) a preset maximum number of repetitions of steps c) to e) has been reached without reaching step f1), and
g) fixing the weights of the recurrent connection unit according to the weights and connection delays that resulted in the complying results of f1), or ending the training.

16. The neural network device according to claim 1, further comprising:
a transmission output time delay ∂t_{i,j}=k_{i,j}×Δt, k_{i,j}=0, 1, . . . , k, 0≤k≤kmax, ti1/10≤Δt≤ti1 and k_{i,j}×Δt≤50ti1, which output time delay is implemented by serially connecting a number 1 of clocked NOT gates between the output of the outputting input/output node and the other inputting input/output node either behind or in front of the NOT gates of the first and second chains, where the number 1 of clocked gates is determined as 1=(k_{i,j}×Δt)/clock time period.

17. The neural network device according to claim 4, wherein the at least one connection (wi,j) between the input/output node (IOᵢ) of the corresponding cell (nci) and the input/output node (IOⱼ) of the another one of the cells (ncj) of the recurrent connection unit (RCU) is implemented as an electric voltage divider or a transmission gate coupling for transmission of the output (hᵢ) of the corresponding damped electrical harmonic oscillator.

18. The neural network device according to claim 5, wherein the output time delay is implemented as an electric inductivity or a clocked output gate for transmission of the output (hᵢ) of a corresponding damped electrical harmonic oscillator.

19. The neural network device according to claim 9, wherein:
nr of the n cells with r=3 or 4 or 5 or 6 and 8≤nr and nr≤n(r−1), are arranged in an r-th network layer (Lr) and the recurrent connection unit (RCU) comprises, for each of the nr cells (cᵢ), at least one connection (wi,j) between the input/output node (IOᵢ) of the corresponding cell (nci) of the r-th network layer (Lr) and the input/output node (IOⱼ) of at least another one of the cells (ncj) of the r-th network layer (Lr) configured to transmit the resulting damped harmonic oscillation (hᵢ) output from the input/output node (IOᵢ) of the corresponding cell (nci) to the input/output node (IOⱼ) of the another one of the cells (cⱼ), and
the recurrent connection unit (RCU) comprises:
feedforward connections (wi,j) between the input/output nodes (IOᵢ) of the n(r−1) cells (nci) of the (r−1)-th network layer and the input/output nodes (IOⱼ) of the nr cells (ncj) of the r-th network layer configured to transmit the resulting damped harmonic oscillation (hᵢ) output from the input/output nodes of the corresponding cells (nci) of the n(r−1) cells (nci) of the (r−1)-th network layer to the input/output nodes of the corresponding cells of the nr cells (ncj) of the r-th network layer to establish a minimum potential feed forward connectivity of 10% and a maximum potential feed forward connectivity of 100%, and
feedback connections (wj,i) between the input/output nodes (IOⱼ) of the nr cells (ncj) of the r-th network layer and the input/output nodes (IOᵢ) of the n(r−1) cells (nci) of the (r−1)-th network layer configured to transmit the resulting damped harmonic oscillation (hⱼ) output from the input/output nodes of the corresponding cells of the nr cells (ncj) of the (r−1)-th network layer to the input/output nodes (IOᵢ) of the corresponding cells (nci) of the (r−1)-th network layer to establish a minimum potential feedback connectivity of 10% and a maximum potential feedback connectivity of 100%.

20. A neural network device comprising a recurrent neural network for processing the time-series input data (S (t)) that is implemented in electric digital or analogue hardware, comprising:
a plurality of n damped electrical harmonic oscillators (DHOi, i=1 to n), n≥8, the oscillation of each of which follows the general second order differential equation for damped harmonic oscillators of xᵢ(t):xᵢ(t)+2βᵢxᵢ(t)+ω₀ᵢ²xᵢ(t)=0 with βᵢ=damping factor and ω₀ᵢ=natural frequency of an undamped oscillation with βᵢ=Rᵢ/Lᵢ and ω₀ᵢ²=1/LᵢCᵢ, Rᵢ=resistance, Lᵢ=inductance and Cᵢ=capacity for a corresponding damped electrical RLC harmonic oscillator, each of the n damped electrical harmonic oscillators being one cell (nci) of the neural network,
each of the cells (nci) having an input/output node (IOᵢ) configured to receive a cell input (xᵢ) in the form of an electric input of the corresponding damped electrical harmonic oscillator and to output the resulting damped harmonic oscillation (hᵢ),
the input/output node (IOᵢ) comprising:
an input connection (ICᵢ) configured to receive any input to the cell and to output said input via a transistor implemented input (ICSᵢ) for the corresponding damped electrical harmonic oscillator DHOi having a saturating non-linear transfer function as the cell input (xᵢ), and
an output connection (OCᵢ) configured to output the resulting damped harmonic oscillation (hᵢ), and
a recurrent connection unit (RCU) comprising, for each of the cells (cᵢ), at least one connection (wi,j) between the input/output node (IOᵢ) of the corresponding cell (nci) and the input/output node (IOⱼ) of at least another one of the cells (ncj) for transmitting the resulting damped harmonic oscillation (hᵢ) output from the input/output node (IOᵢ) of the corresponding cell (nci) to the input/output node (IOⱼ) of the another one of the cells (cⱼ),
wherein:
i) one or more of the damped electric harmonic oscillators (DHOi, i=1 to n) of the plurality of n damped electric harmonic oscillators is/are a corresponding damped electrical RLC harmonic oscillator DHOi implemented with voltage controlled oscillators as CMOS cross coupled differential oscillators or CMOS ring oscillators, each of the n damped harmonic oscillators being one cell (nci) of the neural network, and/or
ii) one or more of the damped electric harmonic oscillators (DHOi, i=1 to n) of the plurality of n damped electric harmonic oscillators is/are a corresponding damped electrical harmonic oscillator DHOi implemented with analog elements including integrators and potentiometers as voltage controlled oscillators, each of the n damped harmonic oscillators being one of the cells (nci) of the neural network.
